(19) United States
(12) Patent Application Publication
(10) Pub. No.: US 2025/0362216 A1
(43) Pub. Date: Nov. 27, 2025

(54) INFORMATION PROCESSING METHOD, INFORMATION PROCESSING APPARATUS, AND MICROSCOPE SYSTEM

(71) Applicant: SONY GROUP CORPORATION, TOKYO (JP)

(72) Inventors: AYUMU TAGUCHI, TOKYO (JP); TETSURO KUWAYAMA, TOKYO (JP); HIROKAZU TATSUTA, TOKYO (JP); TOMOHIKO NAKAMURA, TOKYO (JP); KAZUHIRO NAKAGAWA, TOKYO (JP)

(21) Appl. No.: 18/873,965

(22) PCT Filed: Jun. 12, 2023
(86) PCT No.: PCT/JP2023/021790

§ 371 Date: Dec. 11, 2024

(30) Foreign Application Priority Data
Jun. 20, 2022 (JP) 2022-099075

(51) Int. Cl. G01N 15/075; G06T 7/00

(52) U.S. Cl. CPC G01N 15/075; G06T 7/97; G06T 2207/10064

(57) ABSTRACT

To provide a technique of handling a fluorescence image captured and acquired by using an optical system in which fluorescence intensity in a captured image changes according to a focal position, in consideration of focal characteristics.

An information processing method includes: a step of analyzing an observation fluorescence image captured and acquired by using an optical system in which fluorescence intensity in a captured image changes according to a focal position and acquiring an observation fluorescence intensity; and a step of deriving a fluorescent molecule concentration in an observation sample from the observation fluorescence intensity while collating with reference standard data that associates a standard fluorescent molecule concentration and a standard fluorescence intensity with each other. The reference standard data is obtained on the basis of the standard fluorescence intensity and the standard fluorescent molecule concentration, the standard fluorescence intensity being derived from a plurality of reference fluorescence images that is a plurality of fluorescence images of a reference sample captured and acquired by using an optical system in which fluorescence intensity in a captured image changes according to a focal position, the plurality of reference fluorescence images having different focal positions at the time of imaging from each other, and the standard fluorescent molecule concentration being obtained from a fluorescent molecule concentration in the reference sample.

### TECHNICAL FIELD

The present disclosure relates to an information processing method, an information processing apparatus, and a microscope system.

### BACKGROUND ART

There is known a fluorescence microscope that irradiates a fluorescent-stained specimen (sample) stained with a fluorescent staining reagent with excitation light to generate fluorescence in the fluorescent-stained specimen, and captures an image of the fluorescence.

The information processing apparatus disclosed in Patent Document 1 corrects luminance of captured image information of a fluorescent-stained specimen acquired by a fluorescence microscope on the basis of a fading coefficient indicating ease of reducing fluorescence intensity of a fluorescent staining reagent. With this arrangement, it is possible to reduce the influence of “brown color of a fluorescent substance” in which the fluorescence intensity of the fluorescent substance decreases according to the intensity of excitation light and an elapse of irradiation time of the excitation light on the captured image information, and the captured image information can also be acquired in a shorter time by increasing the intensity of the excitation light.

### CITATION LIST

### Patent Document

Patent Document 1: International Publication No. 2020/022038 A

### SUMMARY OF THE INVENTION

### Problems to be Solved by the Invention

In order to capture and acquire a fluorescence image of a sample stained with a fluorescent staining reagent, a so-called confocal microscope is used in some cases. The confocal microscope includes an optical system (for example, an optical system having a pinhole or an elongated slit) in which fluorescence intensity in a captured image changes according to a focal position, and is advantageous for reducing an influence of fluorescence from a portion other than a focal plane and capturing a high-contrast, high-resolution fluorescence image.

On the other hand, in a fluorescence image (for example, fluorescence intensity) captured and acquired by the confocal microscope, fluorescence from a fluorescent molecule at a location shifted from the focal plane is not sufficiently reflected, and thus, unique focal characteristics are exhibited in the thickness direction (optical axis direction) of the sample. Due to this focal characteristics, there is a case where it is not appropriate to handle a fluorescence image captured by a confocal microscope in the similar manner as a fluorescence image captured by a general dark field microscope.

An object of the present disclosure is to provide a technique of handling a fluorescence image captured and acquired by using an optical system in which fluorescence intensity in a captured image changes according to a focal position, in consideration of the focal characteristics.

### SOLUTIONS TO PROBLEMS

An aspect of the present disclosure relates to an information processing method including the steps of: analyzing an observation fluorescence image that is a fluorescence image of an observation sample captured and acquired by using an optical system in which fluorescence intensity in a captured image changes according to a focal position and acquiring an observation fluorescence intensity representing fluorescence intensity in the observation fluorescence image; and deriving a fluorescent molecule concentration in the observation sample from the observation fluorescence intensity while collating with reference standard data that associates a standard fluorescent molecule concentration and standard fluorescence intensity with each other, in which the reference standard data is obtained on the basis of the standard fluorescence intensity and the standard fluorescent molecule concentration, the standard fluorescence intensity being derived from a plurality of reference fluorescence images that is a plurality of fluorescence images of a reference sample captured and acquired by using an optical system in which fluorescence intensity in a captured image changes according to a focal position, the plurality of reference fluorescence images having different focal positions at the time of imaging from each other, and the standard fluorescent molecule concentration being obtained from a fluorescent molecule concentration in the reference sample.

The plurality of reference fluorescence images may be analyzed to acquire a reference fluorescence intensity representing fluorescence intensity in each of the reference fluorescence images, a reference fluorescence intensity characteristic that associates a focal position and the reference fluorescence intensity with each other may be acquired from the reference fluorescence intensity of each of the plurality of reference fluorescence images, a standard thickness reference fluorescence intensity characteristic representing the fluorescence intensity characteristic of the reference sample in a case where the reference sample is assumed to have a standard thickness may be derived on the basis of the reference fluorescence intensity characteristic and a thickness of the reference sample in an optical axis direction, and the standard fluorescence intensity may be derived on the basis of a thickness of the observation sample in the optical axis direction and the standard thickness reference fluorescence intensity characteristic.

The standard thickness reference fluorescence intensity characteristic may represent the fluorescence intensity characteristic of the reference sample in a case where the reference sample is assumed to have an infinitely thin thickness.

A Fourier desired thickness fluorescence intensity characteristic may be acquired on the basis of an inner product between a Fourier observation sample thickness function and a Fourier standard thickness reference fluorescence intensity characteristic, the Fourier observation sample thickness function being obtained on the basis of Fourier transform of a rectangular function corresponding to the thickness of the observation sample in the optical axis direction, and the Fourier standard thickness reference fluorescence intensity characteristic being obtained on the basis of Fourier transform of the standard thickness reference fluorescence intensity characteristic, and the standard fluorescence intensity may be acquired on the basis of inverse Fourier transform of the Fourier desired thickness fluorescence intensity characteristic.

The Fourier standard thickness reference fluorescence intensity characteristic may be derived on the basis of F_{L} (k)·G_{L}*(k)/(G_{L}*(k)·G_{L} (k)+ε²), in a case where a function obtained by performing Fourier transform on the reference fluorescence intensity characteristic is represented by “F_{L}(k)”, a function obtained by performing Fourier transform on the rectangular function corresponding to the thickness of the reference sample in the optical axis direction is represented by “G_{L}(k)” and a complex conjugate of a function obtained by performing Fourier transform on the rectangular function is represented by “G_{L}*(k)”, and a minute number other than 0 is represented by “ε”.

The minute number “ε” may be a value that is equal to or less than 1/1000 of the maximum value of the absolute value of the value indicated by the function obtained by performing the Fourier transform on the reference fluorescence intensity characteristic.

Smoothing processing may be applied to the Fourier desired thickness fluorescence intensity characteristic to correct data of a singular point in the Fourier desired thickness fluorescence intensity characteristic on the basis of data before and after the singular point, and the standard fluorescence intensity may be acquired on the basis of the Fourier desired thickness fluorescence intensity characteristic of after the smoothing processing.

A singular point correction filter is applied to the Fourier desired thickness fluorescence intensity characteristic in the smoothing processing, and the data of the singular point of the Fourier desired thickness fluorescence intensity characteristic is corrected to the data obtained by linear interpolation based on data before and after the data of the singular point.

The thickness of the reference sample in the optical axis direction used in deriving the standard thickness reference fluorescence intensity characteristic is derived on the basis of a frequency at which an amplitude of a function obtained by performing Fourier transform on the reference fluorescence intensity characteristic indicates zero.

A plurality of observation fluorescence images having different focal positions at the time of imaging from each other may be analyzed to acquire the observation fluorescence intensity of each of the plurality of observation fluorescence images, an observation fluorescence intensity characteristic that associates a focal position and the observation fluorescence intensity with each other can be acquired from the observation fluorescence intensity of each of the plurality of observation fluorescence images, and the Fourier observation sample thickness function may be acquired on the basis of the thickness of the observation sample in the optical axis direction, the thickness being derived on the basis of a frequency at which an amplitude of a function obtained by performing Fourier transform on the observation fluorescence intensity characteristic indicates zero.

Another aspect of the present disclosure relates to an information processing method including the steps of: analyzing a plurality of sample fluorescence images that is a plurality of fluorescence images of a sample captured and acquired by using an optical system in which fluorescence intensity in a captured image changes according to a focal position, the plurality of sample fluorescence images having different focal positions at the time of imaging from each other, to acquire sample fluorescence intensity representing fluorescence intensity in each of the sample fluorescence images; acquiring a sample fluorescence intensity characteristic that associates a focal position and the sample fluorescence intensity with each other from the sample fluorescence intensity of each of the plurality of sample fluorescence images; and deriving a thickness of the sample in an optical axis direction on the basis of a frequency at which an amplitude of a function obtained by performing Fourier transform on the sample fluorescence intensity characteristic indicates zero.

The sample is stained with a first fluorescent staining reagent that stains the sample according to a specific cell state and a second fluorescent staining reagent that stains the sample regardless of the specific cell state, and the plurality of sample fluorescence images is an image based on fluorescence of the second fluorescent staining reagent.

Another aspect of the present disclosure relates to an information processing apparatus including: an image acquisition unit that captures and acquires an observation fluorescence image that is a fluorescence image of an observation sample by using an optical system in which fluorescence intensity in a captured image changes according to a focal position; a fluorescence intensity acquisition unit that acquires an observation fluorescence intensity representing fluorescence intensity in the observation fluorescence image by analyzing the observation fluorescence image; and a fluorescent molecule concentration deriving unit that derives a fluorescent molecule concentration in the observation sample from the observation fluorescence intensity while collating with reference standard data that associates a standard fluorescent molecule concentration and standard fluorescence intensity with each other, in which the reference standard data is obtained on the basis of the standard fluorescence intensity and the standard fluorescent molecule concentration, the standard fluorescence intensity being derived from a plurality of reference fluorescence images that is a plurality of fluorescence images of a reference sample captured by using an optical system in which fluorescence intensity in a captured image changes according to a focal position, the plurality of reference fluorescence images having different focal positions at the time of imaging from each other, and the standard fluorescent molecule concentration being obtained from a fluorescent molecule concentration in the reference sample.

Another aspect of the present disclosure relates to a microscope system including: a light irradiation unit that irradiates an observation sample with excitation light that excites a fluorescent reagent; an imaging device that images a sample irradiated with the excitation light by using an optical system in which fluorescence intensity in a captured image changes according to a focal position, and acquires a fluorescence image; and an information processing apparatus that analyzes the fluorescence image, in which the information processing apparatus includes the processes of: analyzing an observation fluorescence image that is a fluorescence image of the observation sample to acquire an observation fluorescence intensity representing fluorescence intensity in the observation fluorescence image; and deriving a fluorescent molecule concentration in the observation sample from the observation fluorescence intensity while collating with reference standard data that associates a standard fluorescent molecule concentration and standard fluorescence intensity with each other, and the reference standard data is obtained on the basis of the standard fluorescence intensity and the standard fluorescent molecule concentration, the standard fluorescence intensity being derived from a plurality of reference fluorescence images that is a plurality of fluorescence images of a reference sample captured by using an optical system in which fluorescence intensity in a captured image changes according to a focal position, the plurality of reference fluorescence images having different focal positions at the time of imaging from each other, and the standard fluorescent molecule concentration being obtained from a fluorescent molecule concentration in the reference sample.

### BRIEF DESCRIPTION OF DRAWINGS

FIG. 1 is a block diagram illustrating a configuration example of an information processing system.

FIG. 2 is a diagram illustrating a specific example of a fluorescence spectrum acquired by a fluorescence signal acquisition unit.

FIG. 3 is a diagram illustrating a method of generating a combined fluorescence spectrum by a combining unit.

FIG. 4 is a diagram illustrating fluorescence spectra of AF546 and AF555 in a case where a wavelength resolution is set to 8 nm.

FIG. 5 is a diagram illustrating fluorescence spectra of AF546 and AF555 in a case where a wavelength resolution is set to 1 nm.

FIG. 6 is a diagram illustrating an example of a combined fluorescence spectrum generated from the fluorescence spectra illustrated in A to D of FIG. 3.

FIG. 7 is a block diagram illustrating a more specific configuration example of a separation processing unit of the present embodiment.

FIG. 8 is a diagram illustrating a specific example of a combined autofluorescence reference spectrum.

FIG. 9 is a diagram illustrating a specific example of a combined fluorescence reference spectrum.

FIG. 10 is a diagram illustrating a schematic configuration of an example of a microscope system (information processing system).

FIG. 11 is a conceptual diagram of an example of an information processing system including an information processing apparatus and a measurement system.

FIG. 12A is a conceptual diagram illustrating an example of an imaging method of a fluorescent-stained specimen (observation sample) by a normal microscope (measurement system) not including a confocal optical system.

FIG. 12B is a conceptual diagram illustrating an example of an imaging method of a fluorescent-stained specimen by a line confocal microscope.

FIG. 12C is a conceptual diagram illustrating an example of an imaging method of a fluorescent-stained specimen by the line confocal microscope.

FIG. 13 is a diagram for explaining a concept of lamination synthesis of fluorescence intensity in a fluorescence image of a fluorescent-stained specimen captured and acquired by a confocal microscope, by using the fluorescent-stained specimen.

FIG. 14 is a diagram for explaining, by using a graph, a concept of lamination synthesis of fluorescence intensity in a fluorescence image of a fluorescent-stained specimen captured and acquired by a confocal microscope.

FIG. 15A is a diagram for explaining, by a physical image, acquisition of a fluorescence intensity characteristic of a reference sample having a desired thickness.

FIG. 15B is a diagram for explaining, by a graph, acquisition of the fluorescence intensity characteristic of a reference sample having a desired thickness.

FIG. 16 is a graph 16 representing a function F(ω) derived by Fourier transform of the fluorescence intensity characteristic of a sample.

FIG. 17 is a conceptual diagram for explaining a convolution operation by using Fourier transform and inverse Fourier transform.

FIG. 18 is a flowchart illustrating an example of processing of acquiring reference standard data.

FIG. 19A is a diagram for explaining an example of thickness estimation of a reference sample.

FIG. 19B is a diagram for explaining an example of thickness estimation of a reference sample.

FIG. 19C is a diagram for explaining an example of thickness estimation of a reference sample.

FIG. 20 is a graph for explaining, on the Fourier space, calculation processing of the fluorescence intensity characteristic of a virtual reference sample having the same thickness as an observation sample.

FIG. 21A is a graph comparing, on the Fourier space, the fluorescence intensity characteristic of a virtual reference sample having a desired thickness obtained by calculation processing with the fluorescence intensity characteristic of an actual reference sample having a desired thickness obtained by an actual measurement value.

FIG. 21B is a graph illustrating a range indicated by a reference sign “XXIB” in FIG. 21A in an enlarged manner.

FIG. 22A is a graph illustrating the “fluorescence intensity characteristic of a reference sample” which is the same as those in FIGS. 21A and 21B, but including a range not illustrated in FIGS. 21A and 21B.

FIG. 22B illustrates a graph obtained by applying a singular point correction filter to the graph (in particular, the fluorescence intensity characteristic of the reference sample having a desired thickness obtained by the calculation processing) illustrated in FIG. 22A.

FIG. 23 is a graph illustrating, on a real space, an example of actual measurement values and calculated values of the fluorescence intensity characteristic of a reference sample having a desired thickness.

FIG. 24A is a flowchart illustrating an example of processing of acquiring a fluorescent molecule concentration in an observation sample.

FIG. 24B is a flowchart illustrating another example of processing of acquiring a fluorescent molecule concentration in an observation sample.

### MODE FOR CARRYING OUT THE INVENTION

Hereinafter, an embodiment of the present disclosure will be exemplarily described with reference to the drawings. In the following description and drawings, elements having substantially the same function are denoted by the same reference numerals.

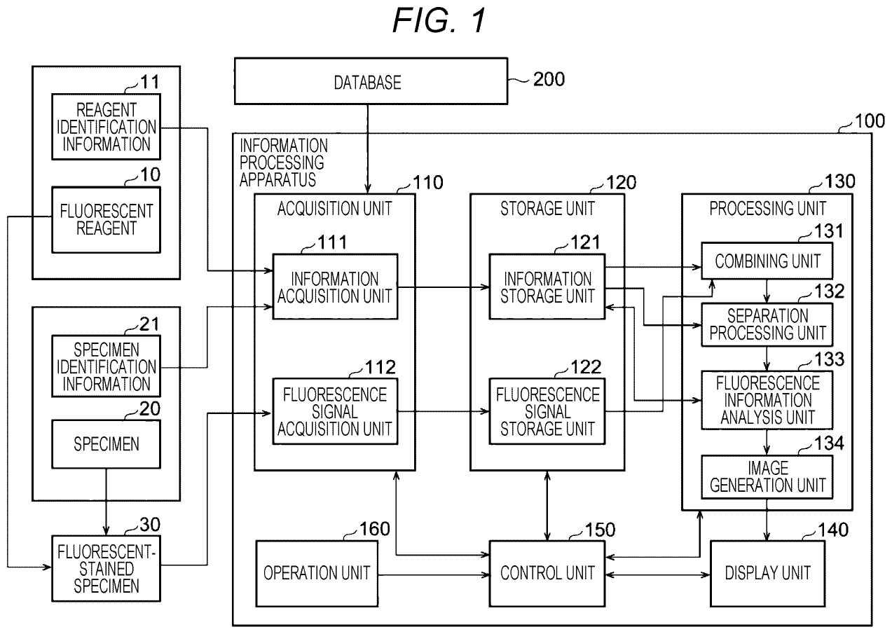

FIG. 1 is a block diagram illustrating a configuration example of an information processing system.

The information processing system illustrated in FIG. 1 includes an information processing apparatus 100 and a database 200.

### [Fluorescent Reagent 10]

A fluorescent reagent 10 is a chemical used for staining a specimen 20. As the fluorescent reagent 10, for example, a fluorescent antibody (including a primary antibody used for direct labeling or a secondary antibody used for indirect labeling), a fluorescent probe, a nuclear staining reagent, or the like can be used, but a type of the fluorescent reagent 10 is not limited thereto. The fluorescent reagent 10 is given identification information (hereinafter referred to as “reagent identification information 11”) that enables identification of the fluorescent reagent 10 (or a production lot of the fluorescent reagent 10), and is managed by the reagent identification information 11. The reagent identification information 11 is configured as, for example, bar code information (for example, one-dimensional bar code information, or two-dimensional bar code information), but is not limited to the bar code information. Even in a case of the same product, properties of the fluorescent reagent 10 are different for every production lot in accordance with a production method, a state of a cell from which the antibody is acquired, and the like. For example, in the fluorescent reagent 10, a spectrum, a quantum yield, a fluorescent labeling rate, and the like are possibly different for every production lot. Therefore, the fluorescent reagent 10 of the present embodiment is managed for each production lot by being given the reagent identification information 11. With this arrangement, the information processing apparatus 100 can perform fluorescence separation also in consideration of a slight difference in properties that appears for every production lot.

### [Specimen 20]

The specimen 20 is prepared from an analyte or a tissue sample collected from a human body for the purpose of pathological diagnosis or the like. The specimen 20 may be a tissue section, a cell, or a microparticle. Regarding the specimen 20, there are no limitations in a type of tissue used (for example, an organ or the like), a type of a target disease, an attribute of a subject (for example, age, sex, blood type, race, and the like), and a lifestyle of the subject (eating habits, exercise habits, smoking habits, and the like). The tissue section can include, for example, a pre-stained section of a tissue section to be stained (also simply referred to as a “section”), a section adjacent to the stained section, a section different from the stained section in the same block (a section sampled from the same location as the stained section), a section in a different block in the same tissue (a section sampled from a different location from the stained section), a section collected from a different patient, and the like. The specimen 20 is given identification information (also referred to as “specimen identification information 21”) from which each specimen 20 can be identified, and is managed by the specimen identification information 21. Similarly to the reagent identification information 11, the specimen identification information 21 is configured as, for example, bar code information (for example, one-dimensional bar code information, or two-dimensional bar code information), but is not limited to the bar code information. The specimen 20 has different properties in accordance with a type of tissue used, a type of a target disease, an attribute of a subject, a lifestyle of the subject, and the like. For example, in the specimen 20, a measurement channel, a spectrum, or the like varies in accordance with the type of tissue used or the like. Therefore, the specimen 20 according to the present embodiment is individually managed by being given the specimen identification information 21. With this arrangement, the information processing apparatus 100 can perform fluorescence separation also in consideration of a slight difference in properties appearing for every specimen 20.

### [Fluorescent-Stained Specimen 30]

A fluorescent-stained specimen 30 is prepared by staining the specimen 20 with the fluorescent reagent 10. In the fluorescent-stained specimen 30 of the present embodiment, it is assumed that the specimen 20 is stained with one or more fluorescent reagents 10. The number of fluorescent reagents 10 used for staining the specimen 20 is not particularly limited. Furthermore, an appropriate staining method is determined by a combination of the specimen 20 and the fluorescent reagent 10, or the like, and is not particularly limited.

### [Information Processing Apparatus 100]

As illustrated in FIG. 1, the information processing apparatus 100 includes an acquisition unit 110, a storage unit 120, a processing unit 130, a display unit 140, a control unit 150, and an operation unit 160. The information processing apparatus 100 can be, for example, a fluorescence microscope, but is not necessarily limited to the fluorescence microscope. That is, the information processing apparatus 100 can be constituted of an optional apparatus (for example, a personal computer (PC)), and a specific configuration and use thereof are not limited.

### [Acquisition Unit 110]

The acquisition unit 110 is configured to acquire information to be used for various types of processing of the information processing apparatus 100. As illustrated in FIG. 1, the acquisition unit 110 includes an information acquisition unit 111 and a fluorescence signal acquisition unit 112.

### [Information Acquisition Unit 111]

The information acquisition unit 111 acquires information regarding the fluorescent reagent 10 (hereinafter, also referred to as “reagent information”) and information regarding the specimen 20 (hereinafter, also referred to as “specimen information”). More specifically, the information acquisition unit 111 acquires the reagent identification information 11 given to the fluorescent reagent 10 used to generate the fluorescent-stained specimen 30 and the specimen identification information 21 given to the specimen 20. For example, the information acquisition unit 111 acquires the reagent identification information 11 and the specimen identification information 21 by using a barcode reader or the like. Then, the information acquisition unit 111 acquires the reagent information from the database 200 on the basis of the reagent identification information 11, and acquires the specimen information from the database 200 on the basis of the specimen identification information 21. The information acquisition unit 111 stores the reagent information and the specimen information acquired in this manner in an information storage unit 121 described later.

In the present embodiment, the specimen information includes a combined autofluorescence reference spectrum in which a spectrum of an autofluorescent substance in the specimen 20 is combined in the wavelength direction, and the reagent information includes a combined fluorescence reference spectrum in which a spectrum of a fluorescent substance in the fluorescent-stained specimen 30 is combined in the wavelength direction. The combined autofluorescence reference spectrum and the combined fluorescence reference spectrum are also collectively referred to as a “reference spectrum”.

### [Fluorescence Signal Acquisition Unit 112]

The fluorescence signal acquisition unit 112 acquires a plurality of fluorescence signals in a case where the fluorescent-stained specimen 30 is irradiated with a plurality of beams of excitation light having different wavelengths to each other, the plurality of fluorescence signals corresponding to corresponding ones of the plurality of beams of excitation light. More specifically, the fluorescence signal acquisition unit 112 receives light and outputs a detection signal corresponding to an amount of the received light, and a fluorescence spectrum of the fluorescent-stained specimen 30 is acquired on the basis of the detection signal. The characteristics (including a wavelength, intensity, and the like) of the excitation light are determined on the basis of reagent information and the like (that is, information regarding the fluorescent reagent 10 and the like). The fluorescence signal mentioned here is not particularly limited as long as the signal originates from fluorescence, and may be, for example, a fluorescence spectrum.

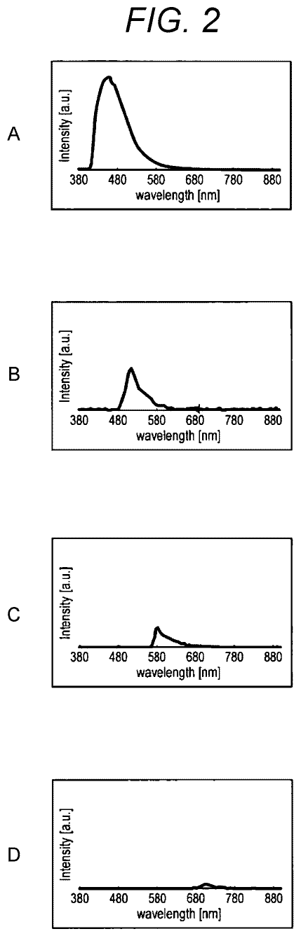

A to D of FIG. 2 are specific examples of fluorescence spectra acquired by the fluorescence signal acquisition unit 112. The fluorescent-stained specimen 30 used to acquire the fluorescence spectra represented by A to D of FIG. 2 contains four types of fluorescent substances: DAPI, CK/AF488, PgR/AF594, and ER/AF647. The fluorescence spectra illustrated in A to D of FIG. 2 are obtained by irradiating the fluorescent-stained specimen 30 with excitation light including light components of 392 [nm](A of FIG. 2), 470 [nm](B of FIG. 2), 549 [nm](C of FIG. 2), and 628 [nm](D of FIG. 2), which are excitation wavelengths of the respective fluorescent substances. Note that, because energy is emitted for fluorescence emission, the fluorescence wavelength is shifted to the longer wavelength side than the excitation wavelength (Stokes shift). The fluorescent substance contained in the fluorescent-stained specimen 30 and the wavelength of the excitation light are not limited. The fluorescence signal acquisition unit 112 stores the acquired fluorescence spectrum acquired in this manner in a fluorescence signal storage unit 122 to be described later.

### [Storage Unit 120]

The storage unit 120 stores information to be used for various types of processing of the information processing apparatus 100 and information obtained by the various types of processing. The storage unit 120 illustrated in FIG. 1 includes the information storage unit 121 and the fluorescence signal storage unit 122.

### [Information Storage Unit 121]

The information storage unit 121 stores, for example, the reagent information and the specimen information acquired by the information acquisition unit 111.

### [Fluorescence Signal Storage Unit 122]

The fluorescence signal storage unit 122 stores a fluorescence signal of the fluorescent-stained specimen 30 acquired by the fluorescence signal acquisition unit 112.

### [Processing Unit 130]

The processing unit 130 is configured to perform various types of processing including fluorescence separation processing. As illustrated in FIG. 1, the processing unit 130 includes a combining unit 131, a separation processing unit 132, and an image generation unit 134.

### [Combining Unit 131]

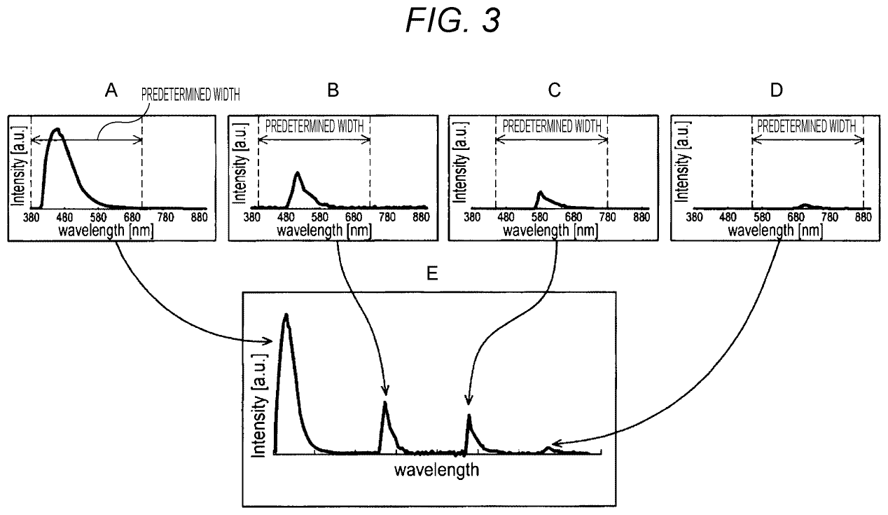

The combining unit 131 generates a combined fluorescence spectrum by combining, in the wavelength direction, at least a part of a plurality of fluorescence spectra acquired by the fluorescence signal acquisition unit 112 and stored in the fluorescence signal storage unit 122. For example, the combining unit 131 extracts data having a predetermined width from each fluorescence spectrum while allowing the data to include a maximum value of fluorescence intensity for each of four fluorescence spectra (see A to D of FIG. 3) acquired by the fluorescence signal acquisition unit 112 described above. A width of a wavelength band in which the combining unit 131 extracts data can be determined on the basis of the reagent information, the excitation wavelength, the fluorescence wavelength, and the like, or may be different for every fluorescent substance. In other words, the width of the wavelength band in which the combining unit 131 extracts data may be different between the fluorescence spectra illustrated in A to D of FIG. 3. Then, as indicated by E of FIG. 3, the combining unit 131 generates one combined fluorescence spectrum by combining the extracted data to each other in the wavelength direction. Because the combined fluorescence spectrum is configured on the basis of pieces of data extracted from the plurality of fluorescence spectra, the wavelengths are not necessarily continuous at a boundary between the pieces of combined data.

On the basis of intensity of the excitation light, the combining unit 131 performs the data combining described above after aligning the intensity of the excitation light corresponding to each of the plurality of fluorescence spectra (in other words, after correcting the plurality of fluorescence spectra). More specifically, the combining unit 131 performs the data combining described above after aligning the intensity of the excitation light corresponding to each of the plurality of fluorescence spectra by dividing each fluorescence spectrum by an excitation power density representing the intensity of the excitation light. With this arrangement, a fluorescence spectrum in a case of irradiating with the excitation light having the same intensity is obtained. In a case where the intensity of the irradiated excitation light is different, intensity of a spectrum (referred to as an “absorption spectrum”) absorbed by the fluorescent-stained specimen 30 is also different according to the irradiation intensity of the excitation light. Therefore, by aligning the intensity of the excitation light corresponding to each of the plurality of fluorescence spectra as described above, the absorption spectrum can be appropriately evaluated.

The intensity of the excitation light in the present description may be excitation power or an excitation power density as described above. The excitation power or the excitation power density may be power or a power density obtained by actually measuring the excitation light emitted from a light source, or may be power or a power density obtained from a drive voltage applied to the light source. The intensity of the excitation light in the present description may be a value obtained by correcting the excitation power density described above by using an absorption rate of each excitation light of a slice to be observed, an amplification factor of a detection signal in a detection system (the fluorescence signal acquisition unit 112 or the like) that detects fluorescence emitted from the slice, or the like. That is, the intensity of the excitation light in the present description may be a power density of excitation light actually contributing to excitation of the fluorescent substance, a value obtained by correcting the power density with the amplification factor or the like of the detection system, or the like. By such correction considering the absorption rate, the amplification factor, and the like, the intensity of the excitation light that changes according to a change in a machine state or an environment can be appropriately obtained, and thus, a combined fluorescence spectrum that enables color separation with higher accuracy can be generated.

Note that a correction value (also referred to as an “intensity correction value”) based on the intensity of the excitation light for each fluorescence spectrum is not limited to a value for aligning the intensity of the excitation light corresponding to each of the plurality of fluorescence spectra, and the correction value may be variously changed. For example, signal intensity of a fluorescence spectrum having an intensity peak on the long wavelength side tends to be lower than signal intensity of a fluorescence spectrum having an intensity peak on the short wavelength side. Therefore, in a case where both of the fluorescence spectrum having an intensity peak on the long wavelength side and the fluorescence spectrum having an intensity peak on the short wavelength side are included in the combined fluorescence spectrum, there is a case where the fluorescence spectrum having an intensity peak on the long wavelength side is hardly taken into account and only the fluorescence spectrum having an intensity peak on the short wavelength side is extracted. In such a case, for example, by setting the intensity correction value for the fluorescence spectrum having an intensity peak on the long wavelength side to a larger value, separation accuracy of the fluorescence spectrum having an intensity peak on the short wavelength side can be enhanced.

Furthermore, the combining unit 131 may correct a wavelength resolution of each of the plurality of fluorescence spectra to be combined, independently of other fluorescence spectra. For example, a fluorescence spectrum of AF546 and a fluorescence spectrum of AF555 have spectrum shapes and peak wavelengths that are almost the same as each other. The fluorescence spectrum of the AF546 and the fluorescence spectrum of the AF555 are different from each other in that the fluorescence spectrum of AF555 has a shoulder at a bottom portion on the high wavelength side, whereas the fluorescence spectrum of the AF546 does not have such a shoulder. As described above, in a case where two fluorescence spectra are close to each other, there arises a problem that the color separation is difficult to be performed on the two fluorescence spectra through spectrum extraction.

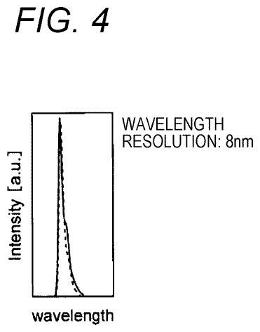

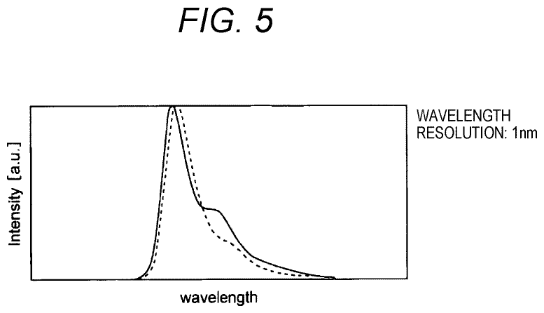

In some cases, this problem can be solved by increasing the wavelength resolution of the combined fluorescence spectrum. FIG. 4 is a diagram illustrating fluorescence spectra of AF546 and AF555 in a case where the wavelength resolution is set to 8 nm. FIG. 5 is a diagram illustrating fluorescence spectra of AF546 and AF555 in a case where the wavelength resolution is set to 1 nm. As illustrated in FIG. 4, in a case where the wavelength resolution is 8 nm, the spectrum shape and the peak wavelength of AF546 substantially coincide with the spectrum shape and the peak wavelength of AF555. Therefore, for example, it is practically difficult to perform the color separation by using the least squares method. On the other hand, in a case where the wavelength resolution is set to eight times the wavelength resolution illustrated in FIG. 4, that is, 1 nm, as illustrated in FIG. 5, the spectrum shape and the peak wavelength of AF546 can be clearly separated from the spectrum shape and the peak wavelength of AF555. This indicates that, even in a case where a plurality of fluorescence spectra having close spectral shapes and peak wavelengths are used, the color separation can be performed by using the fluorescence spectra by increasing the wavelength resolution.

However, if the wavelength resolution is increased, an amount of data of the combined fluorescence spectrum increases, and a necessary memory capacity, calculation cost in the fluorescence separation processing, and the like increase. Therefore, among the plurality of fluorescence spectra to be combined, the combining unit 131 corrects the wavelength resolution to be high for the fluorescence spectrum that is assumed to be difficult to be subjected to color separation, and corrects the wavelength resolution to be low for the fluorescence spectrum that is assumed to be easy to be subjected to color separation. With this arrangement, the color separation accuracy can be improved while suppressing an increase in the amount of data.

Here, a method of generating the combined fluorescence spectrum by using the combining unit 131 will be described with specific examples. In the present description, similarly to the method of generating the combined fluorescence spectrum described above with reference to FIG. 3, a case is exemplified where four fluorescence spectra are combined, the four fluorescence spectra being obtained by irradiating the fluorescent-stained specimen 30 containing four fluorescent substances of DAPI, CK/AF488, PgR/AF594, and ER/AF647 with excitation light having excitation wavelengths of 392 nm, 470 nm, 549 nm, and 628 nm, respectively.

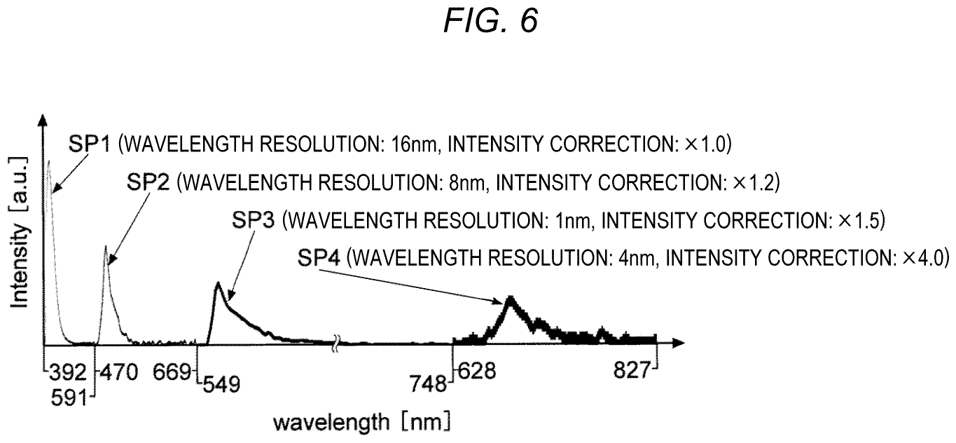

FIG. 6 is a diagram illustrating an example of the combined fluorescence spectrum generated from the fluorescence spectra illustrated in A to D of FIG. 3. As illustrated in FIG. 6, the combining unit 131 extracts a fluorescence spectrum SP1 in a wavelength band of an excitation wavelength of 392 nm or more and 591 nm or less from the fluorescence spectrum illustrated in A of FIG. 3, extracts a fluorescence spectrum SP2 in a wavelength band of an excitation wavelength of 470 nm or more and 669 nm or less from the fluorescence spectrum illustrated in B of FIG. 3, extracts a fluorescence spectrum SP3 in a wavelength band of an excitation wavelength of 549 nm or more and 748 nm or less from the fluorescence spectrum illustrated in C of FIG. 3, and extracts a fluorescence spectrum SP4 in a wavelength band of an excitation wavelength of 628 nm or more and 827 nm or less from the fluorescence spectrum illustrated in D of FIG. 3. Next, the combining unit 131 corrects the wavelength resolution of the extracted fluorescence spectrum SP1 to 16 nm (without intensity correction), corrects the intensity of the fluorescence spectrum SP2 to 1.2 times and corrects the wavelength resolution to 8 nm, corrects the intensity of the fluorescence spectrum SP3 to 1.5 times (without wavelength resolution correction), and corrects the intensity of the fluorescence spectrum SP4 to 4.0 times and corrects the wavelength resolution to 4 nm. Then, the combining unit 131 generates the combined fluorescence spectrum illustrated in FIG. 6 by sequentially joining the corrected fluorescence spectra SP1 to SP4.

Note that FIG. 6 illustrates a case where the fluorescence spectrum is obtained by extracting and joining the fluorescence spectra SP1 to SP4 having a predetermined bandwidth (200 nm width in FIG. 6) from the excitation wavelength at the time when the combining unit 131 acquires each fluorescence spectrum. However, the bandwidths of the fluorescence spectra extracted by the combining unit 131 do not necessarily coincide with each other and may be different from each other. That is, a region extracted from each fluorescence spectrum by the combining unit 131 may be any region including a peak wavelength of each fluorescence spectrum, and the wavelength band and the bandwidth of the extracted region may be appropriately changed. At that time, a shift of the spectrum wavelength due to the Stokes shift may be taken into consideration. In this way, by narrowing down the wavelength band to be extracted, the amount of data can be reduced, and thus, the fluorescence separation processing can be executed at higher speed.

### [Separation Processing Unit 132]

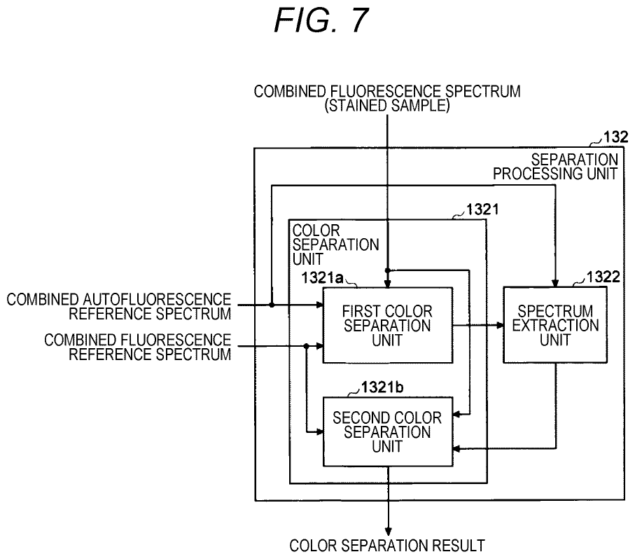

The separation processing unit 132 separates the combined fluorescence spectrum for every molecule. FIG. 7 is a block diagram illustrating a more specific configuration example of the separation processing unit 132 of the present embodiment. The separation processing unit 132 illustrated in FIG. 7 includes a color separation unit 1321 and a spectrum extraction unit 1322.

The color separation unit 1321 includes, for example, a first color separation unit 1321a and a second color separation unit 1321b, and performs color separation, for every molecule, the combined fluorescence spectrum of a stained section (also referred to as a stained sample) input from the combining unit 131.

The spectrum extraction unit 1322 improves the combined autofluorescence reference spectrum so that a more accurate color separation result can be obtained. That is, the spectrum extraction unit 1322 adjusts the combined autofluorescence reference spectrum included in the specimen information input from the information storage unit 121 on the basis of the color separation result by the color separation unit 1321 to allow a more accurate color separation result to be obtained.

More specifically, the first color separation unit 1321a executes the color separation processing using the combined fluorescence reference spectrum and the combined autofluorescence reference spectrum on the combined fluorescence spectrum of the stained sample input from the combining unit 131. With this arrangement, the combined fluorescence spectrum is separated into spectra for every molecule. The first color separation unit 1321a performs the color separation processing by using the combined fluorescence reference spectrum included in the reagent information from the information storage unit 121 and the combined autofluorescence reference spectrum included in the specimen information from the information storage unit 121. Note that, for example, a least squares method (LSM), a weighted least squares method (WLSM), or the like may be used for the color separation processing.

The spectrum extraction unit 1322 performs spectrum extraction processing using the color separation result input from the first color separation unit 1321a on the combined autofluorescence reference spectrum input from the information storage unit 121. The spectrum extraction unit 1322 improves the combined autofluorescence reference spectrum to allow the more accurate color separation result to be obtained, by adjusting the combined autofluorescence reference spectrum on the basis of the result. Note that, for example, non-negative matrix factorization (NMF), singular value decomposition (SVD), or the like may be used for the spectrum extraction processing.

The second color separation unit 1321b executes the color separation processing using the adjusted combined autofluorescence reference spectrum input from the spectrum extraction unit 1322 on the combined fluorescence spectrum of the stained sample input from the combining unit 131. With this arrangement, the second color separation unit 1321b separates the combined fluorescence spectrum into spectra for every molecule. Note that, similarly to the first color separation unit 1321a, for example, the least squares method (LSM), the weighted least squares method (WLSM), or the like may be used for the color separation processing.

FIG. 7 exemplifies a case where the combined autofluorescence reference spectrum is adjusted only once, but the number of times is not limited thereto. The final color separation result may be acquired after inputting the color separation result by the second color separation unit 1321b into the spectrum extraction unit 1322 and performing the processing of adjusting the combined autofluorescence reference spectrum again for once or more in the spectrum extraction unit 1322.

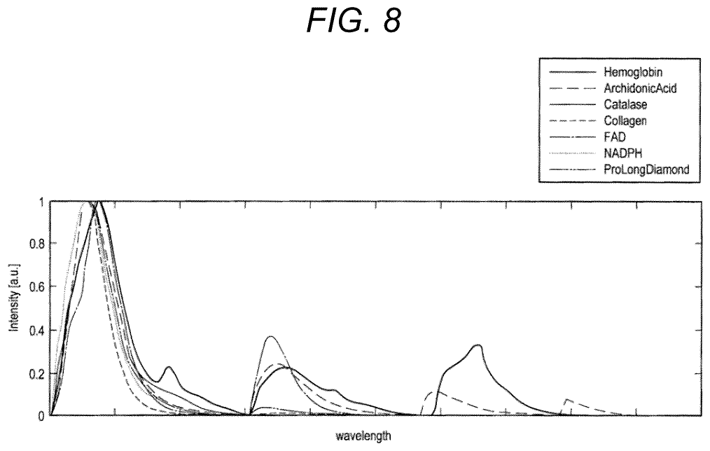

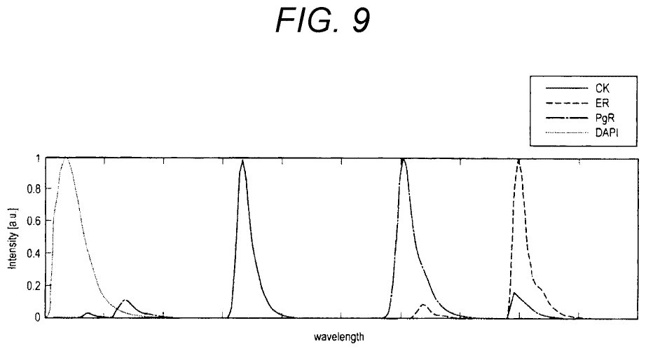

FIG. 8 illustrates a specific example of the combined autofluorescence reference spectrum in a case where the autofluorescent substance is Hemoglobin, ArchidonicAcid, Catalase, Collagen, FAD, NADPH, and ProLongDiamond. FIG. 9 illustrates a specific example of the combined fluorescence reference spectrum in a case where the fluorescent substance is CK, ER, PgR, and DAPI. The combined autofluorescence reference spectrum and the combined fluorescence reference spectrum can both be generated in a similar method as the combined fluorescence spectrum by the combining unit 131, but may be generated in any other method. Specifically, the combined fluorescence reference spectrum and the combined autofluorescence reference spectrum can be generated by combining data of a predetermined wavelength bandwidth in the wavelength direction in a plurality of spectra acquired by a plurality of beams of excitation light including the same wavelengths as the excitation wavelengths used to generate the combined fluorescence spectrum. In this case, the intensities of the excitation light corresponding to the plurality of spectra are assumed to be aligned on the basis of the intensity of the excitation light (for example, the excitation power density), but the present invention is not necessarily limited thereto. Note that the method of generating the combined fluorescence reference spectrum and the combined autofluorescence reference spectrum is not limited to the method described above. For example, the combined fluorescence reference spectrum and the combined autofluorescence reference spectrum may be generated on the basis of a theoretical value, a catalog value, or the like of a spectrum of each substance.

Here, the least squares method that can be used in the color separation processing by the separation processing unit 132 will be described. The least squares method is a calculation method of calculating a color mixing ratio by fitting a reference spectrum to a fluorescence spectrum that is a pixel value of each pixel in an input specimen fluorescence spectrum (for example, a stained specimen fluorescence spectrum (stained specimen image)). Note that, the color mixing ratio is an index indicating a degree at which each substance is mixed. The following Expression (1) is an expression representing a residual obtained by subtracting a reference spectrum St (a fluorescence reference spectrum and an autofluorescence reference spectrum) mixed at a color mixing ratio a, from a fluorescence spectrum (Signal). Note that “Signal (1×number of channels)” in Expression (1) indicates that the fluorescence spectrum (Signal) exists as many as the number of channels of the wavelength. For example, Signal is a matrix representing one or more fluorescence spectra. Furthermore, “St (number of substances×number of channels)” indicates that the reference spectrum exists as many as the number of channels of the wavelength for each of the substances (the fluorescent substance and the autofluorescent substance). For example, St is a matrix representing one or more reference spectra. Furthermore, “a(1×number of substances)” indicates that the color mixing ratio a is provided for each of the substances (the fluorescent substance and the autofluorescent substance). For example, a is a matrix representing the color mixing ratio of each of the reference spectra in the fluorescence spectrum.

$$\begin{matrix}[ Math . 1 ] & \\ Signal ( 1 \times Number of channels ) - a ( 1 \times Number of substances ) * St ( Number of channels \times Number of substances ) & ( 1 )\end{matrix}$$

Then, the separation processing unit 132 calculates the color mixing ratio a of each substance in which a square sum of Expression (1) representing the residual is minimized. The square sum of the residual is minimized in a case where a result of partial differentiation with respect to the color mixing ratio a is 0 in Expression (1) representing the residual. Therefore, the separation processing unit 132 calculates the color mixing ratio a of each substance in which the square sum of the residual is minimized by solving the following Expression (2). Note that “St′” in Expression (2) indicates a transposed matrix of the reference spectrum St. Furthermore, “inv (St*St′)” indicates an inverse matrix of St*St′.

$$\begin{matrix}[ Math . 2 ] & \\ \frac{δ ( Signal - a * St )}{δ a} = 0 & ( 2 )\end{matrix}$$

$$⇔ 2 ( Signal - a * St ) * {St}^{′} = 0$$

$$⇔ ( Signal - a * St ) {St}^{′} = 0$$

$$⇔ Signal * {St}^{′} - a * ( St * {St}^{′} ) = 0$$

$$⇔ a = Signal * {St}^{′} * inv ( St * {St}^{′} )$$

Here, specific examples of each of the values of Expression (1) described above are shown in the following Expressions (3) to (5). The examples of Expressions (3) to (5) indicate a case where the reference spectra (St) of three substances (the number of substances is three) are mixed at different color mixing ratios a in the fluorescence spectrum (Signal).

$$\begin{matrix}[ Math . 3 ] & \\ St = ( \begin{matrix}50 & 100 & 60 & 25 & 4 \\ 10 & 20 & 100 & 20 & 8 \\ 0.1 & 11 & 30 & 100 & 50\end{matrix} ) & ( 3 )\end{matrix}$$

$$\begin{matrix}[ Math . 4 ] & \\ a = ( 321 ) & ( 4 )\end{matrix}$$

$$\begin{matrix}[ Math . 5 ] & \\ Signal = a * St = ( 170.1 351 \; 410 \; 215 \; 78 ) & ( 5 )\end{matrix}$$

Then, a specific example of a calculation result of Expression (2) described above based on each of the values of Expressions (3) and (5) is shown in the following Expression (6). As can be seen from Expression (6), “a=(3 2 1)” (that is, the same value as Expression (4) described above) is correctly calculated as the calculation result.

$$\begin{matrix}[ Math . 6 ] & \\ a = Signal * {St}^{′} * inv ( St * {St}^{′} ) = ( 321 ) & ( 6 )\end{matrix}$$

Note that, as described above, the separation processing unit 132 may extract a spectrum for each fluorescent substance from the fluorescence spectrum by performing calculation related to the weighted least square method instead of the least squares method. In the weighted least squares method, by using the fact that noise of the fluorescence spectrum (Signal), which is the measured value, has a Poisson distribution, weighting is performed to cause an error of a low signal level to be focused. However, an upper limit value at which the weighting is not performed by the weighted least squares method is set as Offset value. Offset value is determined by characteristics of a sensor used for measurement, and the offset value needs to be separately optimized in a case where an imaging element is used as the sensor. In a case of performing the weighted least squares method, the reference spectrum St in Expressions (1) and (2) described above is replaced with St_represented by the following Expression (7). Note that the following Expression (7) means that St is calculated by dividing (in other words, performing element division on) each element (each component) of St represented by the matrix by each corresponding element (each component) in the “Signal+Offset value” also represented by the matrix.

$$\begin{matrix}[ Math . 7 ] & \\ St\_ = \frac{St}{Signal + Offset value} & ( 7 )\end{matrix}$$

Here, the following Expression (8) shows a specific example of St represented by Expression (7) described above in a case where Offset value is 1 and values of the reference spectrum St and the fluorescence spectrum Signal are represented by the Expressions (3) and (5) described above, respectively.

$$\begin{matrix}[ Math . 8 ] & \\ St\_ = \frac{St}{Signal + Offset value} = ( \begin{matrix}0.2922 & 0.2841 & 0.146 & 0.1157 & 0.0506 \\ 0.0584 & 0.0568 & 0.2433 & 0.0926 & 0.1013 \\ 5.8445 {e}^{- 5} & 0.0313 & 0.073 & 0.463 & 0.6329\end{matrix} ) & ( 8 )\end{matrix}$$

Then, a specific example of a calculation result of the color mixing ratio a in this case is shown in the following Expression (9). As can be seen from Expression (9), “a=(3 2 1)” is correctly calculated as the calculation result.

$$\begin{matrix}[ Math . 9 ] & \\ a = Signal * {St\_}^{′} * inv ( St * {St\_}^{′} ) = ( 321 ) & ( 9 )\end{matrix}$$

(about Non-Negative Matrix Factorization (NMF))

A description will be given to non-negative matrix factorization (NMF) used by the separation processing unit 132 to extract the autofluorescence spectrum and/or the fluorescence spectrum. However, it is not limited to the use of the non-negative matrix factorization (NMF), and singular value decomposition (SVD), principal component analysis (PCA), or the like may be used.

FIG. 5 is a diagram for explaining an outline of the NMF. As illustrated in FIG. 5, the NMF decomposes a matrix A of non-negative N rows and M columns (N×M) into a matrix W of non-negative N rows and k columns (N×k) and a matrix H of non-negative k rows and M columns (k×M). The matrix W and the matrix H are determined to cause a mean square residual D between the matrix A and a product (W*H) of the matrix W and the matrix H to be minimized. In the present embodiment, the matrix A corresponds to a spectrum (N is the number of pixels, and M is the number of wavelength channels) before the autofluorescence reference spectrum is extracted. The matrix H corresponds to the extracted autofluorescence reference spectrum (k is the number of autofluorescence reference spectra (in other words, the number of autofluorescent substances), and M corresponds to the number of wavelength channels). Here, the mean square residual D is represented by the following Expression (10). Note that the “norm (D, ‘fro’)” refers to the Frobenius norm of the mean square residual D.

$$\begin{matrix}[ Math . 10 ] & \\ D = \frac{norm ( D , ‘ fro ’ )}{\sqrt{N * M}} & ( 10 )\end{matrix}$$

For factorization in NMF, an iterative method starting with random initial values for the matrix W and the matrix H is used. In the NMF, the value of k (the number of autofluorescence reference spectra) is essential, but the initial values of the matrix W and the matrix H are not essential and can be set as options, and a solution is constant when the initial values of the matrix W and the matrix H are set. Whereas, in a case where the initial values of the matrix W and the matrix H are not set, these initial values are randomly set, and the solution does not become constant.

The specimen 20 has different properties and also has different autofluorescence spectra in accordance with a type of tissue used, a type of a target disease, an attribute of a subject, a lifestyle of the subject, or the like. Therefore, the information processing apparatus 100 can achieve more accurate color separation processing by actually measuring the autofluorescence reference spectrum for every specimen 20 as described above.

Note that the matrix A, which is an input of the NMF, is a matrix including the same number of rows as the number of pixels N(=Hpix×Vpix) of the stained specimen image and the same number of columns as the number of wavelength channels M, as described above. Therefore, in a case where the number of pixels of the stained specimen image is large or in a case where the number of wavelength channels M is large, the matrix A becomes a very large matrix, calculation cost of the NMF increases, and a processing time becomes long.

In such a case, for example, as illustrated in FIG. 6, by clustering the number of pixels N(=Hpix×Vpix) of the stained image into a designated number of classes N (<Hpix×Vpix), redundancy of the processing time due to enlargement of the matrix A can be suppressed.

In the clustering, for example, spectra similar in the wavelength direction and the intensity direction among stained images are classified into the same class. With this arrangement, an image having a smaller number of pixels than the stained image is generated, which enables the size of a matrix A′ using this image as an input to be reduced.

### [Fluorescence Information Analysis Unit 133]

The fluorescence information analysis unit 133 performs analysis processing of image spectrum data (including a stained fluorescence component image (fluorescence image)) from the separation processing unit 132. Specific processing contents, processing methods, and processing results of the analysis processing executable by the fluorescence information analysis unit 133 are not limited.

However, the fluorescence information analysis unit 133 of the present embodiment executes the analysis processing of deriving a fluorescent molecule concentration in a sample (a reference sample and/or an observation sample) from the fluorescence intensity in a fluorescence image of the sample. Furthermore, as necessary, the fluorescence information analysis unit 133 executes the analysis processing of deriving a thickness of a sample (a reference sample and/or an observation sample) from the fluorescence image (particularly, focal position characteristics of the fluorescence intensity)) of the sample. Detailed examples of the above analysis processing will be described later.

The fluorescence information analysis unit 133 may read data used for the analysis processing from the information storage unit 121. Furthermore, the fluorescence information analysis unit 133 can store data used for the analysis processing and data obtained as a result of the analysis processing in the information storage unit 121. The data used for the analysis processing by the fluorescence information analysis unit 133 and the data obtained as a result of the analysis processing may be directly provided from the fluorescence information analysis unit 133 to various processing units, or may be read from the information storage unit 121 by the various processing units, and are used for various types of processing as necessary.

For example, data representing the fluorescent molecule concentration in the sample acquired as a result of the analysis processing by the fluorescence information analysis unit 133 may be transmitted to the image generation unit 134 and used for image generation processing to be described later in the image generation unit 134. Furthermore, although not illustrated, data representing the fluorescent molecule concentration in the sample acquired by the fluorescence information analysis unit 133 may be provided to the display unit 140 and the control unit 150 to be displayed on the display unit 140 or used for control processing by the control unit 150.

### [Image Generation Unit 134]

The image generation unit 134 illustrated in FIG. 1 generates image information on the basis of image spectrum data (including the stained fluorescence component image) obtained as a result of a series of processing (including the color separation processing on the fluorescence spectrum) in the separation processing unit 132. The image generation unit 134 may acquire such image spectrum data from the separation processing unit 132 or from a processing unit (for example, the fluorescence information analysis unit 133) other than the separation processing unit 132. For example, the image generation unit 134 can generate the image information by using a fluorescence spectrum corresponding to one or more fluorescent substances, or can generate the image information by using an autofluorescence spectrum corresponding to one or more autofluorescent substances. Note that the number and combination of the fluorescent substances (molecules) or autofluorescent substances (molecules) used by the image generation unit 134 to generate the image information are not particularly limited. Furthermore, in a case where various types of processing (for example, segmentation, S/N value calculation, and the like) using the fluorescence spectrum or the autofluorescence spectrum after separation are performed, the image generation unit 134 may generate image information indicating results of the various types of processing.

### [Display Unit 140]

The display unit 140 presents image information to an implementer (user), by displaying the image information generated by the image generation unit 134 on a display. Furthermore, the display unit 140 may notify the implementer of the data acquired by the fluorescence information analysis unit 133 (for example, the fluorescent molecule concentration in the observation sample and various types of data derived from the fluorescent molecule concentration) by displaying the data on the display. Note that a type of the display used as the display unit 140 is not particularly limited. Furthermore, although not described in detail, the image information generated by the image generation unit 134 may be presented to the implementer by being projected by a projector (display unit 140) or printed by a printer (display unit 140). In other words, a method of outputting the image information is not particularly limited.

### [Control Unit 150]

The control unit 150 is a functional configuration that comprehensively controls overall processing performed by the information processing apparatus 100. For example, the control unit 150 controls the start, the end, and the like of various types of processing as described above, on the basis of operation input performed by the implementer via the operation unit 160. Examples of the various types of processing include, for example, adjustment processing of a placement position of the fluorescent-stained specimen 30, irradiation processing with excitation light on the fluorescent-stained specimen 30, spectrum acquisition processing, generation processing of an autofluorescence component correction image, color separation processing, image information generation processing, image information display processing, and the like. Note that control contents of the control unit 150 are not particularly limited. For example, the control unit 150 may control processing (for example, processing related to an operating system (OS)) generally performed in a general-purpose computer, a personal computer (PC), a tablet PC, or the like.

### [Operation Unit 160]

The operation unit 160 receives an operation input from the implementer (user). More specifically, the operation unit 160 includes various types of input means such as a keyboard, a mouse, a button, a touch panel, and/or a microphone, and the implementer can perform various inputs to the information processing apparatus 100 by operating the input means. Information regarding the input performed via the operation unit 160 is provided to the control unit 150.

### [Database 200]

The database 200 is a device that manages information such as the reagent information and the specimen information. More specifically, the database 200 manages the reagent identification information 11 and the reagent information in association with each other, and manages the specimen identification information 21 and the specimen information in association with each other. With this arrangement, the information acquisition unit 111 can acquire, from the database 200, the reagent information on the basis of the reagent identification information 11 of the fluorescent reagent 10, and the specimen information on the basis of the specimen identification information 21 of the specimen 20.

The reagent information managed by the database 200 is assumed to be information including a measurement channel and the combined fluorescence reference spectrum unique to a fluorescent substance included in the fluorescent reagent 10, but is not necessarily limited thereto. The “measurement channel” is a concept indicating a fluorescent substance contained in the fluorescent reagent 10, and in an example in FIG. 9, a concept indicating CK, ER, PgR, and DAPI. Because the number of fluorescent substances varies depending on the fluorescent reagent 10, the measurement channel is managed in association with each fluorescent reagent 10 as the reagent information. Furthermore, the combined fluorescence reference spectrum included in the reagent information is, as described above, a fluorescence spectrum in which, for each of the fluorescent substances included in the measurement channel, the fluorescence spectra are combined in the wavelength direction.

Furthermore, the specimen information managed by the database 200 is assumed to be information including a measurement channel and the combined autofluorescence reference spectrum unique to an autofluorescent substance included in the specimen 20, but is not necessarily limited thereto. The “measurement channel” is a concept indicating an autofluorescent substance contained in the specimen 20, and in an example in FIG. 8, a concept indicating Hemoglobin, ArchidonicAcid, Catalase, Collagen, FAD, NADPH, and ProLongDiamond. Because the number of autofluorescent substances varies depending on the specimen 20, the measurement channel is managed in association with each specimen 20 as the specimen information. Furthermore, the combined autofluorescence reference spectrum included in the specimen information is, as described above, a fluorescence spectrum in which, for each of the autofluorescent substances included in the measurement channel, the autofluorescence spectra are combined in the wavelength direction. Note that information managed by the database 200 is not necessarily limited to the information described above.

The system configuration described above with reference to FIG. 1 is merely an example, and the configuration of the above-described information processing system is not limited to the example described above. For example, the information processing apparatus 100 may not necessarily include all of the configurations illustrated in FIG. 1, or may include a configuration not illustrated in FIG. 1.

The above-described information processing system may include an imaging device (for example, a scanner or the like) that acquires a fluorescence spectrum of a sample, and an information processing apparatus 100 that performs processing by using the fluorescence spectrum. In this case, the fluorescence signal acquisition unit 112 illustrated in FIG. 1 can be implemented by the imaging device. Furthermore, the above-described information processing system may include an imaging device that acquires a fluorescence spectrum of a sample, and software to be used for processing using the fluorescence spectrum. In other words, a physical configuration (for example, a memory, a processor, or the like) for storing and executing the software may not be provided in the information processing system. In this case, the fluorescence signal acquisition unit 112 illustrated in FIG. 1 can be implemented by the imaging device, and other configurations of the information processing system can be implemented by the information processing apparatus 100 and the database 200 on which the software is executed. The software is provided to the information processing apparatus 100 (from, for example, a website, a cloud server, or the like) via a network, or provided to the information processing apparatus via any storage medium (for example, a disk or the like). Furthermore, the information processing apparatus 100 on which the software is executed may be various servers (for example, a cloud server or the like), a general-purpose computer, a PC, a tablet PC, or the like. A method by which the software is provided to the information processing apparatus 100 and an information processing apparatus are not limited to the modes described above. Furthermore, the configuration of the information processing system is not limited to the modes described above, and a configuration that can be conceived by a person skilled in the art can be applied on the basis of a technical level at the time of use to implement the above-described information processing system.

As an example, the above-described information processing system may be implemented as a microscope system.

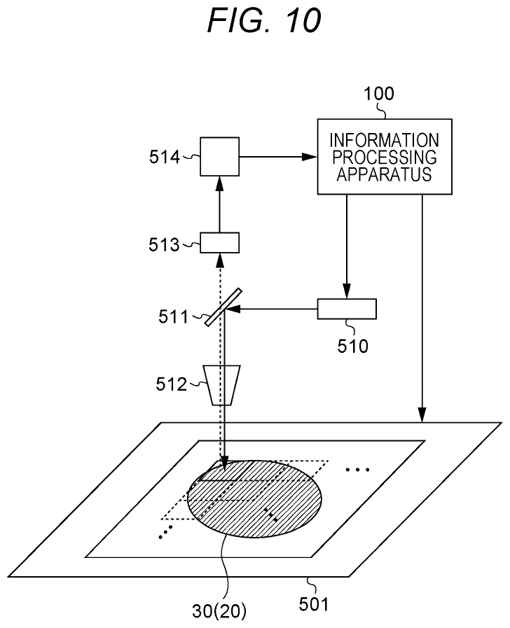

FIG. 10 is a diagram illustrating a schematic configuration of an example of a microscope system (information processing system).

The microscope system of the present embodiment is configured as a line confocal microscope system, and includes a measurement system that acquires an image of the entire imaging region or the region of interest by line scanning. However, the image acquisition method in the microscope system (information processing system) is not limited, and for example, the technology of the microscope system of the present embodiment can also be applied to the confocal microscope system adopting a method other than the line scanning method. The “confocal microscope” mentioned in the following description includes the “line confocal microscope”, and the line confocal microscope may be simply referred to as a confocal microscope. Furthermore, the description of the line confocal microscope is basically applied similarly to other confocal microscopes as well.

The information processing system illustrated in FIG. 10 includes a measurement system and the information processing apparatus 100. The measurement system includes an XY stage 501, an excitation light source 510, a beam splitter 511, an objective lens 512, a spectrometer 513, and a photodetector 514.

The XY stage 501 is a stage on which the fluorescent-stained specimen 30 (or specimen 20) to be analyzed is placed, and is movable in a plane (XY plane) parallel to the placement surface of the fluorescent-stained specimen 30 (or specimen 20).

The excitation light source 510 is a light source that emits excitation light to excite the fluorescent-stained specimen 30 (or specimen 20), and for example, emits a plurality of excitation light beams having different wavelengths along a predetermined optical axis.

Note that, if the fluorescent molecules are evenly distributed in the fluorescent-stained specimen 30, a wavelength-tunable laser light source is not necessarily used as the excitation light source 510, and a measurement system can be configured by using a simple and/or inexpensive optical system.

The beam splitter 511 includes, for example, a dichroic mirror or the like, reflects the excitation light from the excitation light source 510, and transmits fluorescence from the fluorescent-stained specimen 30 (or specimen 20)

The objective lens 512 irradiates the fluorescent-stained specimen 30 (or specimen 20) on the XY stage 501 with the excitation light reflected by the beam splitter 511.

The spectrometer 513 is configured by using one or more prisms, lenses, and the like, and disperses the fluorescence emitted from the fluorescent-stained specimen 30 (or specimen 20) and transmitted through the objective lens 512 and the beam splitter 511 in a predetermined direction.

The photodetector 514 detects the light intensity for every wavelength of fluorescence dispersed by the spectrometer 513, and inputs a fluorescence signal (fluorescence spectrum and/or autofluorescence spectrum) obtained by the detection to the fluorescence signal acquisition unit 112 (see FIG. 1) of the information processing apparatus 100.

In the information processing system illustrated in FIG. 10, in a case where the entire imaging region exceeds a region where image data can be acquired in one time of image capturing (hereinafter referred to as a “visual field”), the image capturing of each visual field is sequentially performed by moving the XY stage 501 and moving the visual field for every time of the image capturing. Then, by tiling image data (hereinafter, referred to as “visual field image data”) obtained by the image capturing of each visual field, wide visual field image data of the entire imaging region is generated. The generated wide visual field image data is stored in, for example, the fluorescence signal storage unit 122 (see FIG. 1). Note that the tiling of the visual field image data may be executed in the acquisition unit 110 of the information processing apparatus 100, may be executed in the storage unit 120, or may be executed in the processing unit 130.

The processing unit 130 can acquire, for example, a fluorescence separation image for every fluorescent molecule (or an autofluorescence separation image for every autofluorescent molecule) by executing the above-described processing on the wide visual field image data obtained in this manner.

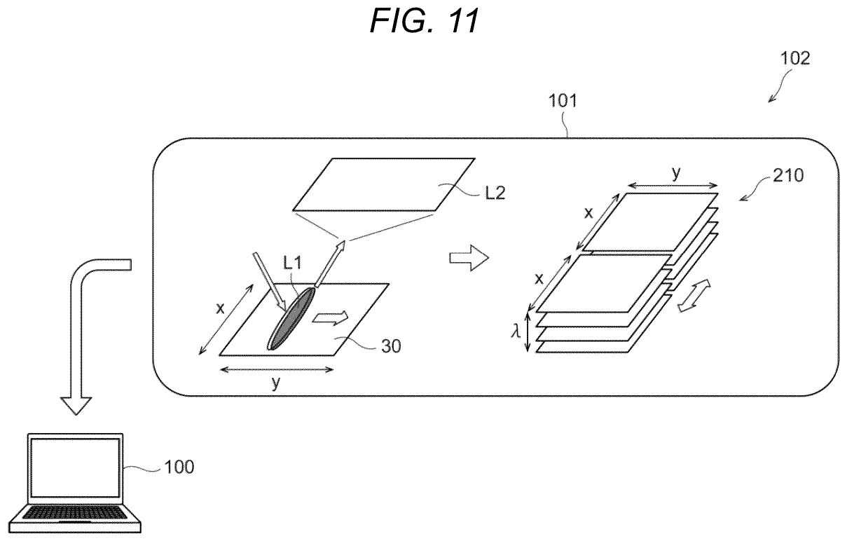

FIG. 11 is a conceptual diagram of an example of an information processing system 102 including the information processing apparatus 100 and a measurement system 101.

The information processing system 102 (in particular, the measurement system 101) irradiates the fluorescent-stained specimen 30 (sample) with excitation light L1, and images fluorescence L2 (in particular, fluorescence L2 after spectroscopy) emitted from the fluorescent molecule in the fluorescent-stained specimen 30 excited by the excitation light L1. With this arrangement, a fluorescence spectrum 210 (fluorescence image) of the fluorescent-stained specimen 30 is obtained.

In the present embodiment, the fluorescent-stained specimen 30 is irradiated with the linear excitation light L1 extending in the x direction at one time, and imaging is performed while allowing the excitation light L1 and the fluorescent-stained specimen 30 to relatively move in the y direction perpendicular to the x direction. Note that, in a case where the x-direction range of the area to be imaged of the fluorescent-stained specimen 30 is larger than the x-direction range of the linear excitation light L1, imaging is performed while the scan position of the excitation light L1 on the fluorescent-stained specimen 30 is sequentially shifted in the x direction.

By using the linear excitation light L1 having a one-dimensional spatial extent as described above, the fluorescence L2 including both the spatial information and the spectral information can be imaged. As a result, the measurement system 101 captures and acquires the fluorescence spectrum 210 configured as three-dimensional data (x,y,λ). That is, the fluorescence spectrum 210 acquired by the measurement system 101 includes a plurality of pieces of image information data, each piece of image information data is image information of the xy plane, and a plurality of xy plane images having different wavelengths/wavelength bands (λ) with respect to the same xy plane is included in the fluorescence spectrum 210.

The fluorescence spectrum 210 acquired by the measurement system 101 in this manner is provided to the information processing apparatus 100, and undergoes various types of processing (see FIG. 1) in the information processing apparatus 100.

### [Fluorescence Information Analysis]

Next, an example of fluorescence information analysis performed by the fluorescence information analysis unit 133 (see FIG. 1) will be described.

First, a characteristic (also referred to as a “fluorescence intensity characteristic”) according to a focal position of the fluorescence intensity in a fluorescence image captured and acquired by the confocal microscope will be described in comparison with a fluorescence intensity characteristic of a fluorescence image captured and acquired by a normal microscope not including the confocal optical system.

In the following description, the description regarding the “thickness” of the sample (specimen) is, in principle, a description regarding the “thickness in the optical axis direction of the measurement system (confocal microscope)” unless otherwise specified.

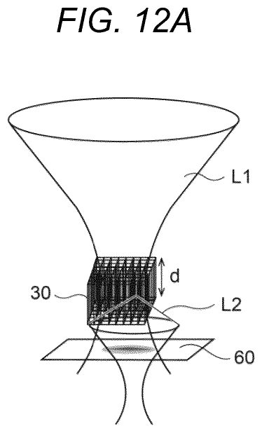

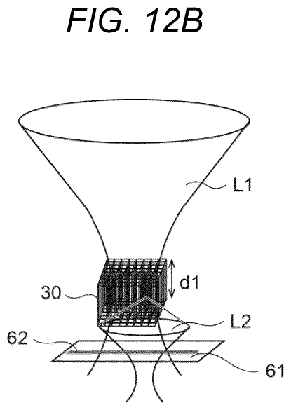

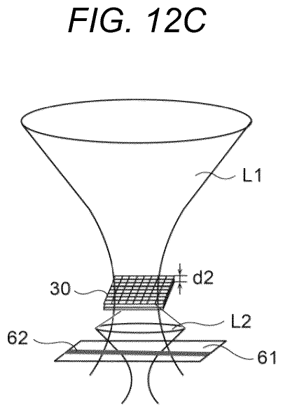

FIG. 12A is a conceptual diagram illustrating an example of an imaging method of the fluorescent-stained specimen 30 (observation sample) by a normal microscope (measurement system) not including the confocal optical system. FIGS. 12B and 12C are conceptual diagrams each illustrating an example of an imaging method of the fluorescent-stained specimen 30 by the line confocal microscope. The fluorescent-stained specimen 30 illustrated in each of FIGS. 12A to 12C emits the fluorescence L2 by being irradiated with the linear excitation light L1 in a state of being accommodated in each of the plurality of column-shaped containers. A thickness d1 of the fluorescent-stained specimen 30 in FIG. 12B is different from a thickness d2 of the fluorescent-stained specimen 30 in FIG. 12C.

In general, in order to detect a specific protein (antigen) that can be present in a cell, a cell tissue is stained by using a fluorescent antibody reagent that binds to the specific protein. The fluorescent molecule bound to and fixed to the specific protein in the cell is excited by the excitation light to emit fluorescence having unique wavelength characteristics.

The density (concentration) of the specific protein (antigen) in the cell can be quantified on the basis of the fluorescence intensity in the captured image (fluorescence image) of the cell tissue obtained in a state where the fluorescent-stained cell tissue is irradiated with excitation light and the fluorescent molecules are emitting fluorescence.

In order to obtain the fluorescent molecule concentration from the fluorescence image of the observation sample in this manner, a reference of a correspondence relationship between the fluorescence intensity and the fluorescent molecule concentration needs to be clarified in the fluorescence image in advance. In other words, the fluorescent molecule concentration in the observation sample can be derived by comparing the fluorescence intensity in the fluorescence image of the observation sample with reference standard data in which the fluorescence intensity and the fluorescent molecule concentration in the fluorescence image are associated with each other.

In a case where the fluorescence image of the observation sample is captured and acquired by a general dark field microscope having no or little focal dependence on fluorescence detection sensitivity, the fluorescence intensity in the fluorescence image does not depend on or hardly depends on a focal position of an optical system used for imaging.

Therefore, in a case where the fluorescence image of the observation sample captured and acquired by the general dark field microscope is used, the fluorescent molecule concentration can be obtained from the fluorescence intensity in the fluorescence image in a simple manner.

That is, by comparing the fluorescence concentration in the fluorescence image of the observation sample with the correspondence relationship as a standard, the fluorescent molecule concentration and the fluorescent molecule number distribution in the observation sample can be accurately calculated. The standard of the “correspondence relationship between the fluorescence intensity and the fluorescent molecule concentration” used at this time is obtained by using the reference sample.

Specifically, a fluorescence image of a reference sample that is fluorescent-stained and whose number of fluorescent molecules per unit area (fluorescent molecule concentration) is known is captured and acquired, and the fluorescence intensity in the fluorescence image is derived. Then, a fluorescence intensity ratio between the fluorescence image of the reference sample and the fluorescence image of the observation sample is obtained, and the fluorescence intensity ratio is multiplied by the fluorescent molecule concentration of the reference sample to calculate the fluorescent molecule concentration of the observation sample.

In this manner, in a case where the fluorescence image of the observation sample is acquired by using the microscope system having no or almost no focal dependency, the fluorescent molecule concentration in the observation sample can be accurately calculated from the fluorescence intensity of the fluorescence image of the observation sample without considering the fluorescence intensity characteristic of the fluorescence image. This is because, in a fluorescence image captured by a general dark field microscope, image blurring occurs in some cases depending on the focal position, but the sum of the fluorescence intensities in the fluorescence image does not depend on or hardly depends on the focal position.

For example, in the normal microscope illustrated in FIG. 12A, the fluorescent-stained specimen 30 is irradiated with the excitation light L1, and the fluorescence L2 emitted from individual fluorescent molecules of the fluorescent-stained specimen 30 is received by an image sensor 60 via an optical system and a spectrometer which are not illustrated. In this case, even if the focal position of the optical system changes, the sum of the intensities of the fluorescence L2 (fluorescence spectrum) emitted from the fluorescent-stained specimen 30 having a thickness d and received by the image sensor 60 basically does not change.

On the other hand, in a case where the confocal microscope captures and acquires a fluorescence image of the observation sample, the fluorescence intensity in the fluorescence image greatly depends on the focal position of the optical system used for imaging. Therefore, in order to appropriately obtain the fluorescent molecule concentration from the fluorescence intensity in the fluorescence image of the observation sample, the fluorescent molecule concentration of the observation sample needs to be obtained in consideration of the focal dependence of the fluorescence intensity in the fluorescence image.

In the line confocal microscope illustrated in each of FIGS. 12B and 12C, a light passage restricting element 61 (light shielding plate) having a slit 62 is provided between the fluorescent-stained specimen 30 and the image sensor (not illustrated). Among the fluorescence L2 emitted from the fluorescent molecules in the fluorescent-stained specimen 30 excited by being irradiated with the linear excitation light L1, only the fluorescence L2 that has passed through the slit 62 is received by the image sensor.

With this arrangement, a one-dimensional fluorescence spectrum of the fluorescent-stained specimen 30 is obtained. Because such imaging of the fluorescent-stained specimen 30 is continuously performed while the excitation light L1 and the fluorescent-stained specimen 30 relatively move as described above, as a result, a planar image (xy planar image: fluorescence spectrum image) of the fluorescent-stained specimen 30 is captured and acquired.

The fluorescence intensity in the fluorescence image captured and acquired by using the optical system in which the slit is incorporated as described above indicates dependency on the focal position. That is, an optical system including the light passage restricting element (light shielding plate having a slit) that restricts the passage of the fluorescence toward the image sensor has a property as a confocal optical system.

In the fluorescent-stained specimen, the fluorescence emitted from the fluorescent molecules located in the focal plane (focusing plane) passes through the slit and is appropriately received by the image sensor. On the other hand, at least a part of the fluorescence emitted from the fluorescent molecules located shifted front or rear from the focal plane in the focal depth direction cannot pass through the slit and is not received by the image sensor.

Therefore, even in a case where the fluorescent molecules are uniformly dispersed and the observation sample has a constant fluorescent molecule concentration, the fluorescence intensity in the fluorescence image captured and acquired by the confocal microscope does not coincide with the fluorescence intensity in the fluorescence image captured and acquired by the normal microscope (see FIG. 12A). In the line confocal microscope (see FIGS. 12B and 12C), because a part of fluorescence is blocked by the light passage restricting element, the fluorescence intensity in the fluorescence image captured and acquired by the line confocal microscope tends to be underestimated as compared with the fluorescence intensity in the fluorescence image captured and acquired by the normal microscope.

In particular, as the thickness of the observation sample increases, the relationship between the fluorescence intensity in the fluorescence image and the fluorescent molecule concentration in the observation sample tends to deviate more greatly from the proportional relationship between the fluorescence intensity and the fluorescent molecule concentration in the fluorescence image captured and acquired by the normal microscope. Therefore, by the simple method based on the fluorescence image captured and acquired by the normal microscope, the fluorescent molecule concentration in the observation sample cannot be appropriately determined from the fluorescence intensity in the fluorescence image captured and acquired by the confocal microscope.

As described above, due to the focal dependency of the fluorescence intensity in the fluorescence image captured and acquired by the confocal microscope, the ratio of the fluorescence intensity between samples having different thicknesses is not necessarily proportional to the ratio of the total number of fluorescent molecules contained in the sample. Therefore, at the time of analyzing the fluorescence image captured and acquired by the confocal microscope, the thickness of the sample and the dependency of the fluorescence detection sensitivity on the focal position need to be taken into consideration.

As an example, a container having the same thickness as the observation sample is prepared, and a sample sealed in the container together with a phosphor having a known concentration used for acquiring the fluorescence image of the observation sample can be used as the reference sample. In this case, by capturing the fluorescence image of the reference sample by using the same confocal microscope as the confocal microscope that captures the fluorescence image of the observation sample, the “correspondence relationship between the fluorescence intensity and the fluorescent molecule concentration” that can be used as a reference can be acquired.

That is, assuming that the reference sample has the same thickness as the observation sample and the fluorescent molecules are uniformly distributed in the reference sample, the fluorescence intensity emitted from the unit fluorescent antibody per unit area can be obtained from the fluorescence image of the reference sample. The number of fluorescent molecules per unit area of the observation sample (fluorescent molecule concentration) can be determined from the fluorescence intensity ratio between the reference sample and the observation sample and determined on the basis of the relationship between the fluorescence intensity obtained from the fluorescence image of the reference sample and the fluorescent molecule concentration.

However, an appropriate thickness (thickness in the optical axis direction) required for the observation sample possibly become different for every type of cell. Furthermore, a thin film section sample obtained by slicing a cell with a thickness of several micrometers (μm) by using a slicer is often used as the observation sample, but there is a limit in the accuracy of the thickness of such an observation sample. Therefore, it is assumed that observation samples having various thicknesses are used in the confocal microscope.

Under a situation where it is assumed that the observation samples having various thicknesses are used as described above, it is not realistic from a technical and cost viewpoint to make a reference sample having exactly the same thickness as these observation samples and stained with the same phosphor at the same concentration every time. Furthermore, it is similarly not realistic to prepare reference samples for each of all possible thicknesses.

Therefore, it is not realistic to simulate the characteristics of a specific fluorescent molecule by using a specific optical system and to perform preparation (measurement) assuming a combination of all factors in advance by using the individual optical system.

Furthermore, it is conceivable to measure the “thickness dependence of focal characteristics” of the reference samples of various thicknesses in advance, and correct nonlinearity of the fluorescence intensity in the fluorescence image of the observation sample with respect to the thickness of the observation sample by using a table based on the measurement result. However, because the dependence of the fluorescence intensity in the fluorescence image of the sample with respect to the thickness of the sample also varies depending on the following factors, the fluorescence intensity in the fluorescence image is not necessarily sufficiently optimized by such correction.
Individual difference in light source optical characteristics
Integration of minute shifts in optical characteristics of optical system
Model dependence regarding fluorescence emitted depending on three-dimensional intensity distribution of excitation light and space dependence of light collection efficiency of the fluorescence
Change over time of various factors (including the factors described above)

Furthermore, it is very difficult to make a very thin sample with high thickness accuracy. In particular, in some cases, the thickness varies even among the individual samples, and measurement and correction of such variation in the thickness among the individual samples is required.

Although there is a device that measures the variation in thickness between the samples or the variation in thickness among the individual samples, which are described above, the device requires an external interference optical system separately or a variable wavelength laser is used as excitation light, which leads to a complicated configuration and high cost of the device.

Furthermore, it is also conceivable that a plurality of fluorescence images is acquired by imaging a sample while changing the focal position of the optical system, and the plurality of fluorescence images is used to average and reduce the influence of the slit. However, there is a concern about cell deterioration such as discoloration of fluorescent molecules in the sample due to irradiation with the excitation light, and thus, there is a case where it is difficult to perform a plurality of times of imaging for the same location in the sample.

In the embodiment described below, the focal characteristics of the observation sample having an optional thickness is estimated on the basis of the measurement result of the focal dependence of the fluorescence intensity of the fluorescent-stained reference sample, on the basis of the idea of lamination synthesis described later.

Furthermore, in order to accurately obtain the fluorescence intensity characteristic of the reference sample, it is desirable to accurately grasp the thickness of the reference sample. Therefore, as described later, the thickness of the reference sample can be accurately obtained by using the Fourier transform function of the fluorescence intensity characteristic of the reference sample.

Moreover, the method described above for accurately obtaining the thickness of the reference sample can also be used to accurately obtain the thickness of the observation sample. As a result, “acquisition of the fluorescent molecule concentration in the observation sample” in consideration of the thickness distribution in individual observation samples can also be achieved.

### [Lamination Synthesis]

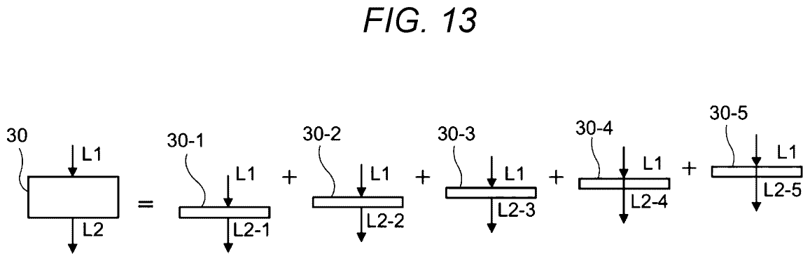

FIG. 13 is a diagram for explaining, by using the fluorescent-stained specimen 30, a concept of lamination synthesis of the fluorescence intensity in the fluorescence image of the fluorescent-stained specimen 30 captured and acquired by the confocal microscope.

As a result of intensive research, the inventor of the present application has newly found a method of approximately representing the focal characteristics of the fluorescence image of the fluorescent-stained specimen 30 having a thickness in the focal direction (that is, the optical axis direction) by synthesis (addition) of the focal characteristics of the fluorescence image of the fluorescent-stained sample having a smaller thickness.

That is, it is assumed a plurality of divided fluorescent-stained specimens 30-1 to 30-5 obtained by dividing the fluorescent-stained specimen 30 into a plurality of pieces (five in the example in FIG. 13) in the optical axis direction.

In this case, the original fluorescence intensity characteristic of the fluorescent-stained specimen 30 is approximated by the fluorescence intensity characteristic obtained by synthesizing (adding) the fluorescence intensity characteristic of the fluorescence L2-1 to L2-5 emitted from the plurality of divided fluorescent-stained specimens 30-1 to 30-5. In other words, in the thickness range of the fluorescent-stained specimen 30, the fluorescence intensity characteristic of the entire fluorescent-stained specimen 30 is approximately obtained by synthesizing the fluorescence intensity characteristic in the fluorescence image acquired while shifting the divided fluorescent-stained specimen having a smaller thickness in the thickness direction (optical axis direction).

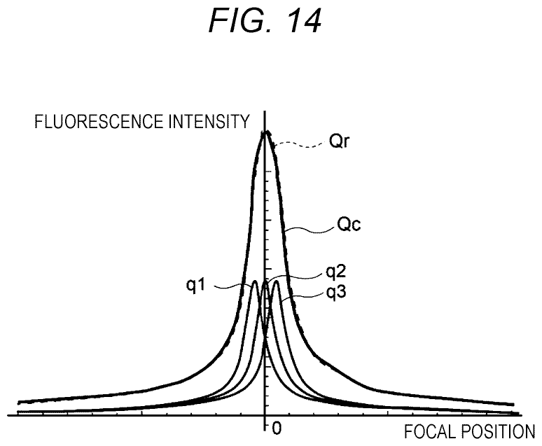

FIG. 14 is a diagram for explaining, by using a graph, a concept of lamination synthesis of the fluorescence intensity in the fluorescence image of the fluorescent-stained specimen captured and acquired by the confocal microscope. The vertical axis in FIG. 14 indicates the fluorescence intensity in the fluorescence image captured and acquired by the confocal microscope. The horizontal axis in FIG. 14 indicates the focal position of the optical system used to capture and acquire the fluorescence image, and the standard focal position is indicated by the origin (“0 (zero)”).

The various types of graphs illustrated in FIG. 14 are based on the case where the fluorescent-stained specimen is divided into three divided fluorescent-stained specimens. That is, FIG. 14 illustrates the fluorescence intensity characteristics q1 to q3 each related to the corresponding one of the three divided fluorescent-stained specimens, and an arithmetic value Qc (solid line) and an actual measurement value Qr (dotted line) of the fluorescence intensity characteristic of the fluorescent-stained specimens.

The arithmetic value Qc of the fluorescence intensity characteristic of the fluorescent-stained specimen is obtained by synthesis (addition) of the fluorescence intensity characteristics q1 to q3 each regarding the corresponding one of the three divided fluorescent-stained specimens. The actual measurement value Qr of the fluorescence intensity characteristic of the fluorescent-stained specimen is derived on the basis of the fluorescence intensity in the fluorescence image of the fluorescent-stained specimen captured and acquired while the focal position of the optical system is changed and by using the confocal microscope. Both the arithmetic value Qc and the actual measurement value Qr of the fluorescence intensity characteristic of the fluorescent-stained specimen illustrated in FIG. 14 show the maximum value (peak value) at the standard focal position (0).

It is apparent from a degree of coincidence between the arithmetic value Qc and the actual measurement value Qr of the fluorescence intensity characteristic of the fluorescent-stained specimen illustrated in FIG. 14 that the idea of the lamination synthesis (see FIG. 13) is correct.

In view of the above-described lamination synthesis concept, the inventor of the present application has further devised a new method of acquiring the fluorescence intensity characteristic of a virtual reference sample having an optional thickness (desired thickness) on the basis of the actual fluorescence intensity characteristic of the reference sample. With this arrangement, the fluorescence intensity characteristic of the virtual reference sample having the same thickness as the observation sample can be calculated. The fluorescence intensity characteristic of the virtual reference sample calculated in this manner can be used as reference standard data (particularly, reference fluorescence concentration) to be referred to for calculating the fluorescent molecule concentration in the observation sample from the fluorescence intensity in the fluorescence image of the observation sample.

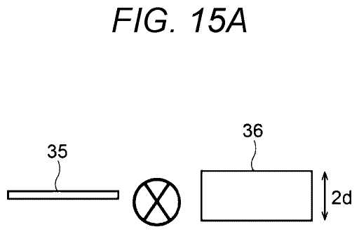

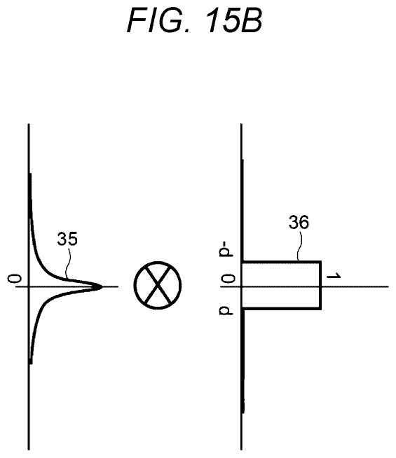

FIG. 15A is a diagram for explaining, by a physical image, acquisition of the fluorescence intensity characteristic of a reference sample having a desired thickness. FIG. 15B is a diagram for explaining, by a graph, acquisition of the fluorescence intensity characteristic of a reference sample having a desired thickness. FIG. 15B illustrates an example of a standard thickness reference fluorescence intensity characteristic 35 based on the focal position (vertical axis) and the fluorescence intensity (horizontal axis), and furthermore, illustrates a rectangular function (desired thickness rectangular function 36) corresponding to the desired thickness on the basis of the focal position (vertical axis) and “0, 1” (horizontal axis).

The fluorescence intensity characteristic (standard thickness reference fluorescence intensity characteristic 35) of the reference sample having the standard thickness (infinitely thin thickness in the present embodiment) is derived from the fluorescence intensity in the fluorescence image of the reference sample captured and acquired by the line confocal microscope and the actual thickness of the reference sample. The “infinitely thin thickness” as used herein means a thickness that is infinitely close to 0 μm.

Then, a plurality of fluorescence intensity characteristic obtained by shifting the standard thickness reference fluorescence intensity characteristic 35 by the standard thickness is synthesized in a range (desired thickness rectangular function 36) corresponding to a desired thickness (2d) of the reference sample. With this arrangement, the fluorescence intensity characteristic of the reference sample having the desired thickness (2d) can be acquired.

In the actual arithmetic operation, the above-described standard thickness reference fluorescence intensity characteristic 35 is calculated by deconvolution of the fluorescence intensity characteristic of the reference sample imaged and acquired by the confocal microscope and the actual thickness of the reference sample. Then, the fluorescence intensity characteristic of the reference sample having the above-described desired thickness (2d) is calculated by convolution of the standard thickness reference fluorescence intensity characteristic 35 and the desired thickness rectangular function 36.

In principle, these arithmetic expressions are expressed by the following Formula 1 using the Fourier transform.

$$\begin{matrix}[ Math . 11 ] & \\ {f}_{s} ( x ) = {F}^{- 1} [ {G}_{S} ( k ) \cdot {F}_{L} ( k ) / {G}_{L} ( k ) ] [ x ] & Formula 1\end{matrix}$$

In Formula 1 described above, “fₛ(x)” represents fluorescence intensity characteristic of the reference sample having a desired thickness, and “F_{L}(k)” represents fluorescence intensity characteristic (reference fluorescence intensity characteristic) of the actual reference sample imaged and acquired by the confocal microscope. “G_{L}(k)” represents the function after the Fourier transform of the rectangular wave (rectangular function) corresponding to the actual thickness of the reference sample, and “G,(k)” represents the function after the Fourier transform of the rectangular wave (rectangular function) corresponding to the desired thickness. “F⁻¹[k][x]” is an operator representing the inverse Fourier transform.

### [Calculation of Thickness of Sample]

Next, a method of accurately estimating the thickness of the sample on the basis of the fluorescence intensity characteristic of the sample will be exemplarily described.

In order to accurately calculate the fluorescence intensity characteristic (fₛ(x)) of the reference sample having a desired thickness on the basis of Formula 1 described above, the actual thickness (see “G_{L}(k)”) of the reference sample needs to be accurately grasped.

As a result of intensive studies, the inventor of the present application has newly found a method of accurately obtaining the actual thickness of the reference sample from the fluorescence intensity characteristic of the actual reference sample, by applying the logic of calculating the fluorescence intensity characteristic of the virtual reference sample having a desired thickness on the basis of Formula 1 described above.

That is, from Formula 1 described above, it is found that the fluorescence intensity characteristic of the reference sample having a desired thickness is calculated by convolution of the function representing the fluorescence intensity characteristic of the reference sample having the standard thickness (infinitely thin thickness) and the rectangular function corresponding to the desired thickness.

Meanwhile, as a basic property of the rectangular function, the Fourier transform of the rectangular function (following Formula 2) is expressed by a Sinc function (following Formula 3).

$$\begin{matrix}[ Math . 12 ] & \\ f ( x ) = \{ \begin{matrix}1 & ( \vert x \vert < d ) \\ 0 & ( \vert x \vert > d )\end{matrix} & Formula 2\end{matrix}$$

$$\begin{matrix}[ Math . 13 ] & \\ F ( ω ) = F [ f ( x ) ] = \frac{1}{2 π} {\int }_{- ∞}^{∞} f ( x ) \cdot {e}^{- i ω x} d x = \frac{1}{2 π} {\int }_{- d}^{d} {e}^{- i ω x} dx = \frac{d}{π} \frac{sin ω d}{ω d} = \frac{d}{π} sinc ω d & Formula 3\end{matrix}$$

As is clear from Formula 3 described above, a function F(ω) after the Fourier transform of the rectangular function becomes “0 (zero)” when “ωd” is “πn (where n is an integer excluding 0)” (that is, in the case of “ωd=πn”, F(ω)=0). Therefore, in the case of “ω=πn/d”, the function F(ω) after the Fourier transform of the rectangular function becomes “0 (zero)”.

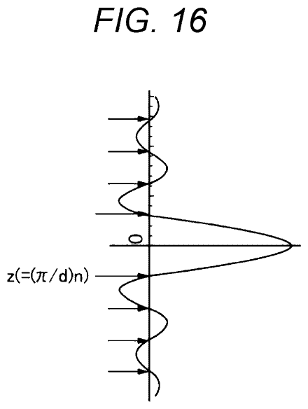

FIG. 16 is a graph representing the function F(ω) derived by Finite Fourier transform (FFT) of the fluorescence intensity characteristic of the sample. The vertical axis (ω) in FIG. 16 corresponds to the “focal position” in the real space, and the horizontal axis (F(ω)) in FIG. 16 corresponds to the “fluorescence intensity” in the real space. In FIG. 16, the origin is represented by a “0 (zero)” point.

In the arithmetic operation of the optical system using the Fourier transform (FFT), in a case where the operation range (sampling section) regarding the focal position is represented by “−L (μm)” to “L (μm)”, one scale on the Fourier space indicates “2π/L”.

Therefore, a zero-cross width (2z) of the function after the Fourier transform of the rectangular function corresponding to the thickness of the sample (also referred to as the “Fourier transform function”) and the thickness 2d of the sample satisfy the relationship of the following Formula 4.

$$\begin{matrix}[ Math . 14 ] & \\ ω = \frac{2 π}{L} * z = \frac{π n}{d} \to d = \frac{nL}{2 z} & Formula 4\end{matrix}$$

Note that the zero-cross width (2z) is represented by a distance between zero-cross points (z, −z) appearing at positions opposite to each other centered on the origin (=0). The origin is set at a position where the Fourier transform function indicates the peak value, and the Fourier transform function indicates “0 (zero)” at the zero-cross point (z,-z).

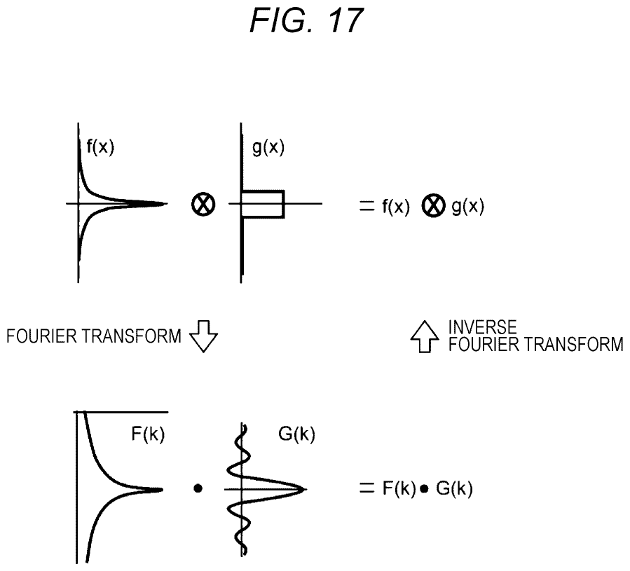

FIG. 17 is a conceptual diagram for explaining the convolution operation by using the Fourier transform and the inverse Fourier transform.

According to the convolution theorem, the convolution of the functions on the real space (see “f(x)” and “g(x)” in FIG. 17) is equivalent to the inner product of the functions on the Fourier space (see “F(k)·G(k)” in FIG. 17).

In view of the above-described lamination synthesis concept, the Fourier transform function of the fluorescence intensity characteristic of the reference sample having a desired thickness is equal to the inner product of the Fourier transform function of the fluorescence intensity characteristic of the reference sample having the infinitely thin thickness and the Fourier transform function of the rectangular function having the desired thickness. That is, the Fourier transform function of the fluorescence intensity characteristic of the reference sample of the desired thickness is equal to the inner product of the standard thickness reference fluorescence intensity characteristic 35 and the desired thickness rectangular function 36.

On the other hand, the Fourier transform function of the actual fluorescence intensity characteristic of the reference sample always becomes zero at a point where the Fourier transform function of the rectangular function corresponding to the actual thickness of the reference sample becomes zero. Therefore, the actual thickness of the reference sample can be derived from the zero point position in the Fourier transform function of the actual fluorescence intensity characteristic of the reference sample.

Specifically, as shown in Formula 4 described above, a zero point position z at which the Fourier transform function of the fluorescence intensity characteristic of the reference sample indicates zero and the thickness 2d of the reference sample satisfy the relationship of “d=nL/(2z)”, that is, “z=nL/(2d)”. Therefore, on the basis of the relationship “z=nL/(2d)”, the actual thickness of the reference sample can be derived from the zero point position in the Fourier transform function of the actual fluorescence intensity characteristic of the reference sample.

Note that the zero point position in the Fourier transform function of the fluorescence intensity characteristic of the reference sample can include a zero point position not derived from the thickness of the reference sample in addition to the zero point position derived from the zero points (“d” and “—d”) of the rectangular function. Therefore, at the time of obtaining the thickness of the reference sample on the basis of the arithmetic operation described above, there is a case where it becomes necessary to select a combination that best fits the expected value of the actual thickness of the reference sample from a plurality of combinations of zero point positions in the Fourier transform function of the fluorescence intensity characteristic of the reference sample.

### [Information Processing Method]

Next, an example of a method of acquiring the fluorescent molecule concentration in the observation sample from the fluorescence intensity in the fluorescence image of the observation sample captured and acquired by the line confocal microscope will be described.

The fluorescence intensity in the following description of the information processing method is the intensity of fluorescence emitted by a specific fluorescent reagent used for staining the observation sample, and is obtained from image spectrum data (fluorescence image) after color separation processing in the separation processing unit 132 (see FIG. 1).

A specific configuration of the information processing system that executes the following information processing method is not limited. For example, in a case where the information processing apparatus 100 having the functional configuration illustrated in FIG. 1 is used, the fluorescence information analysis unit 133 can perform various types of processing by using a fluorescence image described below.

### [Acquisition of Reference Standard Data]

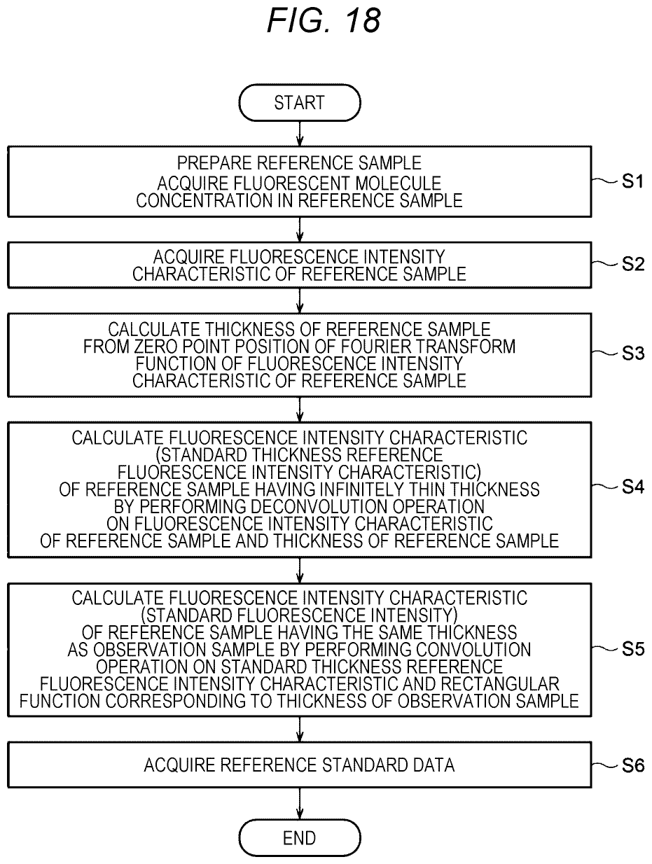

FIG. 18 is a flowchart illustrating an example of processing of acquiring the reference standard data.

### <Preparation of Reference Sample>

First, the reference sample is prepared, and the fluorescent molecule concentration in the reference sample is acquired (S1 in FIG. 18).

The preparation method of the reference sample is not limited. For example, the reference sample may be prepared by sealing the sample in a container with a liquid having a desired concentration of phosphor dissolved therein. Furthermore, the reference sample may be prepared by sealing the sample and the phosphor in a solid glass and by preparing a fluorescent glass having a desired thickness from the solid glass.

Therefore, for example, the reference sample may be prepared by disposing the cell tissue and the phosphor in the container between the flat glasses having a desired interval (usually an interval of several μm to several tens μm). The cell tissue used for the reference sample is usually collected from substantially the same site as the cell tissue used for the observation sample.

In general, as a biological sample (specimen) becomes thinner, it becomes more difficult to prepare the biological sample, and the properties of the biological sample tend to become unstable. Therefore, the reference sample may be prepared to have a larger thickness than the observation sample. However, the thickness of the reference sample is not limited, and may be equal to or less than the thickness of the observation sample.

The phosphor used for preparing the reference sample is a phosphor (fluorescent reagent) used for staining the observation sample or a phosphor exhibiting a fluorescence wavelength characteristic equivalent to that of the fluorescent reagent.

The fluorescent molecule concentration in the reference sample is, for example, known data obtained from the concentration of phosphor in the material used in the preparation of the reference sample (including the preparation of the material on which the reference sample is based).

### <Calculation of Thickness of Reference Sample>

Thereafter, the fluorescence intensity characteristic of the reference sample is acquired by the information processing system including the line confocal microscope and the information processing apparatus described above (S2). Specifically, a plurality of fluorescence images of the reference sample is acquired by the line confocal microscope while having the focal position z of the optical system changed.

Imaging of the fluorescence of the reference sample and imaging of the fluorescence of the observation sample are performed by using the same line confocal microscope (in particular, the same optical system). However, imaging of the fluorescence of the reference sample and imaging of the fluorescence of the observation sample may be performed by using different line confocal microscopes (in particular, different optical systems). In that case, imaging of the fluorescence of the reference sample and imaging of the fluorescence of the observation sample are performed by using “different line confocal microscopes (particularly different optical systems)” exhibiting substantially the same optical characteristics (particularly focal characteristics).

The information processing apparatus analyzes the plurality of fluorescence images of the reference sample acquired in this manner to derive the fluorescence intensity characteristic f(z) of the reference sample.

Thereafter, the thickness of the reference sample is calculated from the zero point position of the Fourier transform function F(k) of the fluorescence intensity characteristic f(z) of the reference sample (S3).

Specifically, by applying a discrete Fourier transform based on any method (for example, FFT) to the fluorescence intensity characteristic f(z) of the reference sample, the Fourier transform function F(k) (=Fourie[f(z),k]) of the fluorescence intensity characteristic of the reference sample is acquired.

Then, the focal position where the square of the absolute value of the complex number of the Fourier transform function F(k), which is (|F(k)|\hat{ }2), indicates zero or a value near zero (that is, a local minimum value sufficiently smaller than other pieces of data) is acquired.

In the Fourier transform function F(k), the absolute value of the complex number is zero or a value near zero constitutes a substantially symmetric data string centered on the focusing position.

Therefore, the zero point position of the Fourier transform function F(k) often appears at a substantially symmetrical position centered on the origin (F(0)) of the Fourier transform function F(k). For example, in a case where “k1” is a zero point (that is, F(k1)=0), “—k1” also indicates a zero point (that is, F(−k1)=0) in many cases.

By using such symmetry of the zero point positions of the Fourier transform function F(k), the paired zero point positions can be accurately detected.

Note that, in the Fourier transform function F(k), points at which the square of the absolute value of the complex number indicates zero and a near zero value are also referred to as a “zero point” and a “near zero point”, respectively. In addition, a pair of the “zero point” and the “near zero point” indicating symmetry is also referred to as a “zero point pair”.

In a case where a plurality of the zero point pairs are generated in the Fourier transform function F(k), it is effective to select a zero point pair corresponding to the thickness closest to the thickness of the reference sample.

Specifically, the thickness (thickness candidate) of the reference sample corresponding to each of the plurality of zero point pairs exhibiting symmetry centered on the origin is calculated, and a thickness candidate considered to be closest to the thickness of the reference sample is selected from the plurality of thickness candidates. Note that, at the time of calculating the thickness (thickness candidate) of the corresponding reference sample from the zero point pair, for example, the relationship of “d=nL/(2z) (that is, ω=π/2L*z=πn/2d)” in Formula 4 described above can be used.

The thickness candidate selected in this manner can be regarded as the “actual thickness of the reference sample”. The number of the zero point pairs in the Fourier transform function F(k) of the fluorescence intensity characteristic of the actual reference sample is usually several sets (for example, about two to five sets), and thus, it is sufficiently possible to select the thickness candidate considered to be the closest to the thickness of the reference sample from among the plurality of thickness candidates.

### <Thickness Estimation Example of Reference Sample>

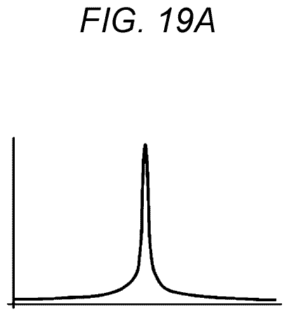

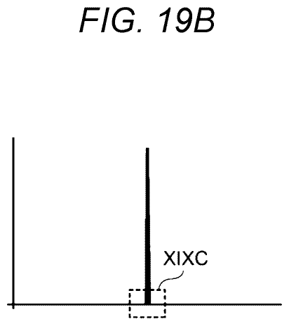

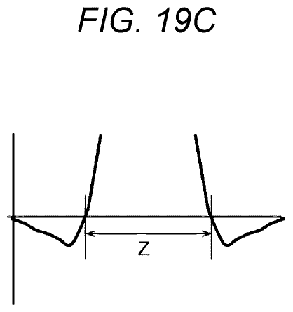

FIGS. 19A to 19C are diagrams each explaining an example of thickness estimation of the reference sample.

FIG. 19A illustrates fluorescence intensity characteristic of the reference sample in the real space. FIG. 19B illustrates fluorescence intensity characteristic of the reference sample on the Fourier space corresponding to the fluorescence intensity characteristic on the real space in FIG. 19A. FIG. 19C illustrates an enlarged range indicated by a reference sign “XIXC” in the fluorescence intensity characteristic illustrated in FIG. 19B.

The inventor of the present application verified whether the thickness of the reference sample calculated on the basis of the above-described estimation method matches the actual measurement value of the thickness of the reference sample.

Specifically, two reference samples having thicknesses of 20 μm and 6.6 μm were prepared, and the thickness of each reference sample was calculated from the fluorescence intensity characteristic of each of these reference samples according to the above-described estimation method.

That is, the fluorescence intensity characteristic of each of the two reference samples having thicknesses of 20 μm and 6.6 μm were acquired by the information processing system including the line confocal microscope (see FIG. 19A), and the Fourier transform function of the fluorescence intensity characteristic was derived by the FFT (see FIG. 19B). At this time, the fluorescence intensity characteristic of the reference sample was divided into 10240 parts in the focal position range of “—1024 μm to +1024 μm”. One scale in the Fourier transform function of the fluorescence intensity characteristic thus obtained corresponds to “2π/1024 μm”.

As a result, the zero-cross width (2z) was approximately “103” in the Fourier transform function of the fluorescence intensity characteristic of the reference sample having a thickness of 20 μm. Furthermore, the zero-cross width (2z) was approximately “310” in the Fourier transform function of the fluorescence intensity characteristic of the reference sample having a thickness of 6.6 μm.

According to Formula 4 (d=nL/(2z)) described above, the thickness 2d of the reference sample is represented by “2d=nL/z”. Meanwhile, for the reference sample having a thickness of 20 μm, “L=1024 μm” and “z=103/2” are satisfied as described above. Therefore, the calculated thickness value 2d of the reference sample having a thickness of 20 μm was obtained as “19.88 μm” (=2048 μm/103=1×1024 μm/(103/2)) (provided that “n=1”). Furthermore, the calculated thickness value 2d of the reference sample having a thickness of 6.6 μm was obtained as “6.61 μm” (=2048 μm/310=1×1024 μm/(310/2)) (provided that “n=1”).

As is apparent from these calculation results, the thickness of the reference sample calculated on the basis of the above-described estimation method sufficiently matches the actual measurement value of the thickness of the reference sample.

### <Calculation of Standard Fluorescence Intensity>

Thereafter, the fluorescence intensity characteristic (standard fluorescence intensity) of the reference sample having the same thickness as the observation sample is calculated (S4 and S5 in FIG. 18).

Specifically, the fluorescence intensity characteristic (standard fluorescence intensity) of the reference sample having the same thickness as the observation sample is calculated according to Formula 1 described above (lamination synthesis).

In Formula 1 described above, the “Fourier transform function of the fluorescence intensity characteristic of the reference sample” used at the time of calculating the thickness of the reference sample may be used as the Fourier transform function (F_{L}(k)) of the fluorescence intensity characteristic of the actual reference sample. Furthermore, the “Fourier transform function of the actual thickness of the reference sample” (G_{L}(k)) is obtained by performing the Fourier transform on the actual thickness of the reference sample (see FIGS. 19A to 19C) calculated from the fluorescence intensity characteristic of the reference sample as described above.

Then, the standard thickness reference fluorescence intensity characteristic 35 (see FIGS. 15A and 15B) is calculated by deconvolution operation (F_{L}(k)/G_{L}(k)) of the fluorescence intensity characteristic of the reference sample and the thickness of the reference sample (S4).

The standard thickness reference fluorescence intensity characteristic 35 obtained in this manner represents the fluorescence intensity characteristic of the reference sample having the infinitely thin thickness. Therefore, the fluorescence intensity characteristic (standard fluorescence intensity) of the reference sample having the same thickness as the observation sample is calculated by the convolution operation on the standard thickness reference fluorescence intensity characteristic 35 and the rectangular function (desired thickness rectangular function 36) corresponding to the thickness of the observation sample (S5).

Specifically, multiplication (inner product) is performed between the standard thickness reference fluorescence intensity characteristic 35 (Fourier standard thickness reference fluorescence intensity characteristic) expressed as the Fourier transform function and a Fourier transform function (G,(k); Fourier observation sample thickness function) which is a rectangular function corresponding to the thickness of the observation sample. Then, by performing the inverse Fourier transform of the Fourier transform function (Fourier desired thickness fluorescence intensity characteristic) acquired as a result of the multiplication, the fluorescence intensity characteristic (desired thickness fluorescence intensity characteristic; standard fluorescence intensity) on the real space of the virtual reference sample having the same thickness as the observation sample is obtained.

### <Avoidance of Division by Zero>

In Formula 1 described above that can be used in the above-described calculation processing, “G_{L}(k) (Fourier transform function of the actual thickness of the reference sample)” exists in the denominator. Therefore, in Formula 1 described above, the zero point (and the near zero point) of “G_{L}(k)” becomes a singular point, and the operation stability and the operation accuracy of the Formula 1 described above are impaired due to the division by “0 (zero)”.

Therefore, from the viewpoint of securing the operation stability and the operation accuracy, it is desirable to use Formula 5 below instead of Formula 1 described above in the above-described calculation processing.

$$\begin{matrix}[ Math . 15 ] & \\ {f}_{s} ( x ) = {F}^{- 1} [ {G}_{S} ( k ) \cdot {F}_{L} ( k ) \cdot {G}_{L}^{*} ( k ) / {G}_{L}^{*} ( k ) \cdot {G}_{L} ( k ) + {ε}^{2} ) ] [ x ] & Formula 5\end{matrix}$$

In Formula 5 described above, similarly to Formula 1, “fₛ(x)” represents the fluorescence intensity characteristic of the reference sample having a desired thickness, and “F_{L}(k)” represents the fluorescence intensity characteristic of the reference sample imaged and acquired by the confocal microscope. “G_{L}(k)” represents the function after the Fourier transform of the rectangular wave (rectangular function) corresponding to the actual thickness of the reference sample, and “G,(k)” represents the function after the Fourier transform of the rectangular wave (rectangular function) corresponding to the desired thickness. “F⁻¹[k][x]” is an operator representing the inverse Fourier transform.

“G_{L}*(k)” represents a complex conjugate of “G_{L}(k)”. “ε” represents a minute number other than “0 (zero)”.

In Formula 5 described above, each of the numerator and the denominator of Formula 1 described above is multiplied by the complex conjugate (G_{L}*(k)) of the Fourier transform function of the rectangular wave corresponding to the actual thickness of the reference sample. Furthermore, in Formula 5 described above, the square of the minute number (ε²) is added to the denominator.

In Formula 5 described above, the denominator is a value other than “0” also for the singular point that results in “denominator=0” in Formula 1 described above. Therefore, according to Formula 5 described above, division by “0” is avoided, and the stability and the accuracy of the operation are improved.

Note that “F_{L}(k)/G_{L}(k)” in Formula 1 and “F_{L} (k)·G_{L}*(k)/(G_{L}*(k)·G_{L} (k)+ε²)” in Formula 5 represent the Fourier transform functions of the fluorescence intensity characteristic of the reference sample having the infinitely thin thickness.

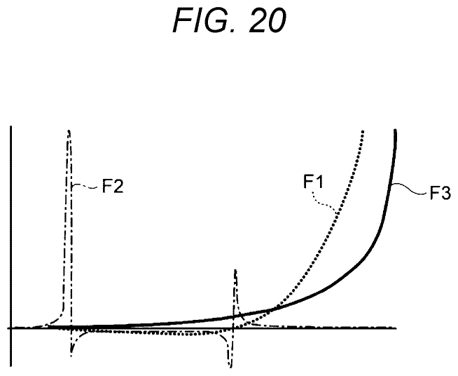

FIG. 20 is a graph for explaining, on the Fourier space, the calculation processing of the fluorescence intensity characteristic of the virtual reference sample having the same thickness as the observation sample.

In FIG. 20, “F1” (dotted line) represents the fluorescence intensity characteristic (F_{L}(k)) of the reference sample imaged and acquired by the confocal microscope. In FIG. 20, “F2” (dashed-dotted line) represents a conversion function for converting the fluorescence intensity characteristic of the reference sample into the fluorescence intensity characteristic of the observation sample, and corresponds to a set of items other than “F_{L}(k)” on the right side of each of Formulas 1 and 5 described above. In FIG. 20, “F3” (solid line) represents the fluorescence intensity characteristic of the reference sample having a desired thickness.

In FIG. 20, ideally, the inner product of F1 and F2 coincides with F3.

However, in a case where the zero point of F1 and the singular point of F2 do not coincide with each other, the sign of the inner product of F1 and F2 changes twice in the vicinity of the zero point and the singular point, and as a result, the inner product of F1 and F2 cannot have the same sign and exhibits a steep behavior. As described above, in the vicinity of the zero point of F1 and the singular point of F2, the inner product of F1 and F2 tends to greatly deviate from F3.

Due to the steep behavior of the function based on the inner product of F1 and F2, the finally obtained “fluorescence intensity characteristic of the reference sample having a desired thickness” becomes unstable. Therefore, from the viewpoint of stabilizing the “fluorescence intensity characteristic of the reference sample having a desired thickness”, it is preferable to cause the zero point of F1 to coincide with the singular point of F2.

<Verification of Fluorescence Intensity Characteristic of Reference Sample having Desired Thickness>

By using the actual reference sample having a thickness of “20 μm” in the optical axis direction, the inventor of the present application calculated the fluorescence intensity characteristic of the virtual reference sample having a thickness of “6.6 μm” in the optical axis direction as a desired thickness according to the above-described method. Meanwhile, the inventor of the present application prepared the actual reference sample having a thickness of “6.6 μm” in the optical axis direction, and acquired the fluorescence intensity characteristic based on the actual measurement value of the reference sample.

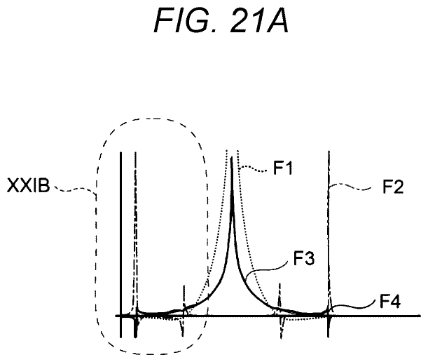

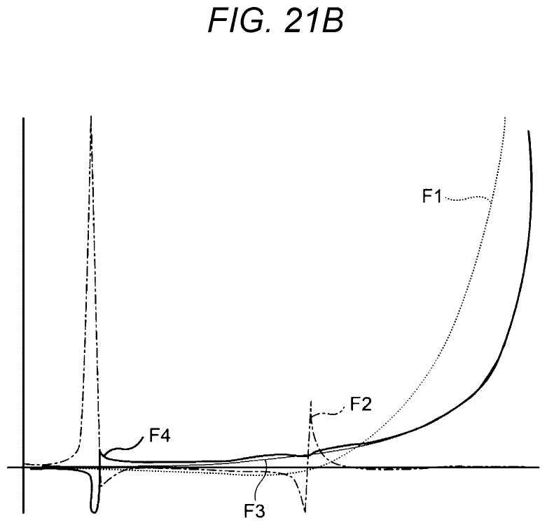

FIG. 21A is a graph comparing, on the Fourier space, the fluorescence intensity characteristic of the virtual reference sample having a desired thickness obtained by the calculation processing with the fluorescence intensity characteristic of the actual reference sample having the desired thickness obtained by the actual measurement value. FIG. 21A illustrates only a part of the fluorescence intensity characteristic of the reference sample (particularly, only the vicinity range of the singular point of the central portion in the fluorescence intensity characteristic of the reference sample). FIG. 21B is a graph illustrating a range indicated by a reference sign “XXIB” in FIG. 21A in an enlarged manner.

In FIGS. 21A and 21B, “F1” (dotted line) represents the fluorescence intensity characteristic (F_{L}(k)) of the reference sample imaged and acquired by the confocal microscope. In FIGS. 21A and 21B, “F2” (dashed-dotted line) represents a conversion function for converting the fluorescence intensity characteristic of the reference sample into the fluorescence intensity characteristic of the observation sample. In FIGS. 21A and 21B, “F3” (thin solid line) represents the fluorescence intensity characteristic of the reference sample having a desired thickness obtained on the basis of the actual measurement value. In FIGS. 21A and 21B, “F4” (thick solid line) represents the fluorescence intensity characteristic of the reference sample having a desired thickness obtained by the inner product of F1 and F2.

In FIGS. 21A and 21B, the higher the degree of coincidence of F4 with respect to F3, the higher the accuracy of the “fluorescence intensity characteristic of the reference sample having a desired thickness” obtained by the above-described calculation processing.

It can be seen from FIGS. 21A and 21B that the degree of coincidence of F4 with respect to F3 is very high. Therefore, it can be said that the accuracy of the “fluorescence intensity characteristic of the reference sample having a desired thickness” obtained by the above-described calculation processing is very high.

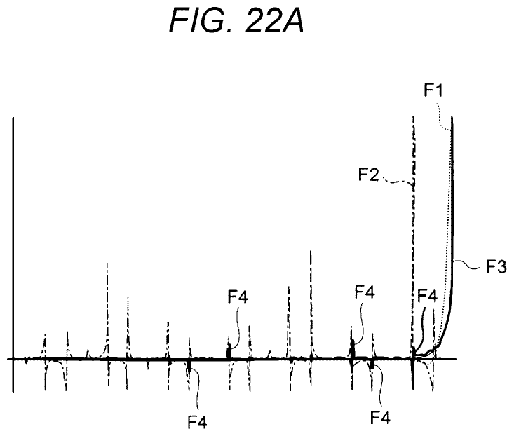

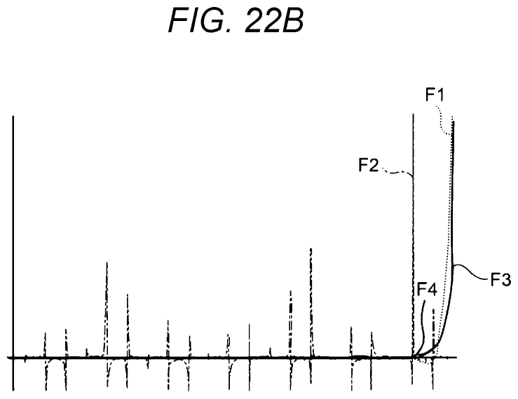

FIG. 22A is a graph illustrating the “fluorescence intensity characteristic of the reference sample” which is the same as those in FIGS. 21A and 21B, but including a range not illustrated in FIGS. 21A and 21B. FIG. 22B illustrates a graph obtained by applying a singular point correction filter to the graph (in particular, the fluorescence intensity characteristic F4 of the reference sample having a desired thickness obtained by the calculation processing) illustrated in FIG. 22A.

As illustrated in FIG. 22A, the fluorescence intensity characteristic (F4) of the virtual reference sample having a desired thickness obtained by the above-described calculation processing suddenly exhibits a steep behavior (also referred to as “spurious”) in some cases at the second singular point and the higher order singular point. Such spurious that possibly occur in the fluorescence intensity characteristic (F4) of the reference sample is considered to indicate a limit of measurement accuracy and model accuracy.

Usually, a range (area) occupied by the spurious in the fluorescence intensity characteristic of the reference sample is sufficiently small. Therefore, the spurious has a very small influence on the calculation result of the fluorescence intensity characteristic of the reference sample having a desired thickness.

However, from the viewpoint of improving the calculation accuracy of the fluorescence intensity characteristic of the reference sample having a desired thickness, it is considered effective to reduce the spurious as much as possible. Therefore, smoothing processing for reducing the spurious may be further performed on the “fluorescence intensity characteristic of the reference sample having a desired thickness” obtained as a result of the above-described calculation processing (see FIG. 22B).

A specific processing content of such smoothing processing is not limited.

As an example, the smoothing processing may be performed on the Fourier transform function (Fourier desired thickness fluorescence intensity characteristic) of the “fluorescence intensity characteristic of the reference sample having a desired thickness”, and the data of the singular point in the Fourier desired thickness fluorescence intensity characteristic may be corrected on the basis of the data before and after the singular point. Specifically, by applying the singular point correction filter to the Fourier desired thickness fluorescence intensity characteristic, the data of the singular point of the Fourier desired thickness fluorescence intensity characteristic may be corrected to data obtained by linear interpolation based on data before and after the data of the singular point.

With this arrangement, the spurious of all the singular points (including the higher order singular points) can be reduced in the “fluorescence intensity characteristic of the reference sample having a desired thickness”, and the “fluorescence intensity characteristic of the reference sample having a desired thickness” closer to the actual measurement value can be calculated. However, because the ratio of the spurious in the entire “fluorescence intensity characteristic of the reference sample having a desired thickness” is very small, the above-described smoothing processing may not be necessarily performed.

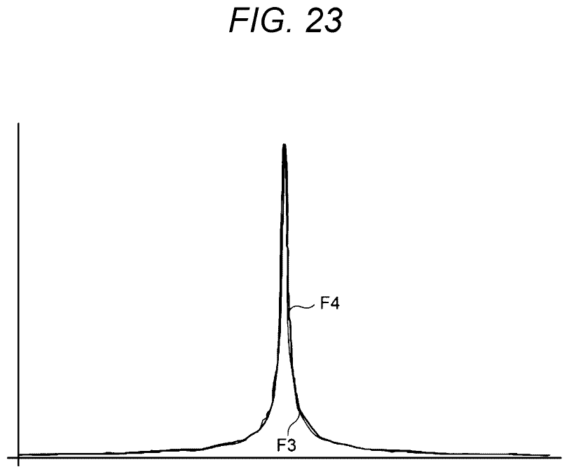

FIG. 23 is a graph illustrating, on the real space, an example of the actual measurement value (F3) and the calculated value (F4) of the fluorescence intensity characteristic of the reference sample having a desired thickness. The actual measurement value and the calculated value (see F3 and F4 in FIG. 23) on the real space are obtained by the inverse Fourier transform of the actual measurement value and the calculated value (see F3 and F4 in FIGS. 22A and 22B) of the above-described “fluorescence intensity characteristic of the reference sample having a desired thickness” expressed as the Fourier transform function.

In FIG. 23, the degree of coincidence of F4 with respect to F3 is very high. Therefore, it can be said that the accuracy of the “fluorescence intensity characteristic of the reference sample having a desired thickness” obtained by the above-described calculation processing is very high.

### <Determination of Reference Standard Data>

The “fluorescence intensity characteristic of the reference sample having a desired thickness” obtained as a result of the above-described series of calculation processing is used as the “standard fluorescence intensity” of the reference standard data.

Furthermore, the “fluorescent molecule concentration of the reference sample”, which is known data, is used as the “standard fluorescent molecule concentration” of the reference standard data.

By associating the standard fluorescence intensity and the standard fluorescent molecule concentration obtained in this manner with each other, the reference standard data is acquired (S6 in FIG. 18).

### [Acquisition of Fluorescent Molecule Concentration in Observation Sample]

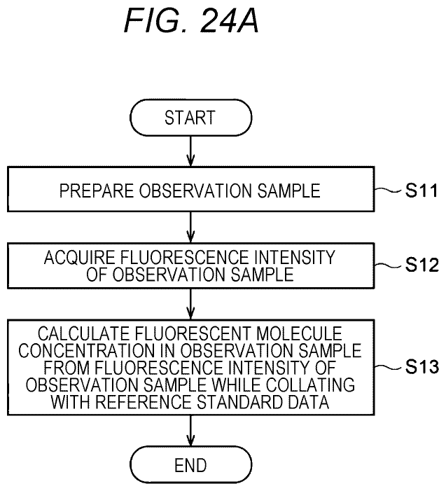

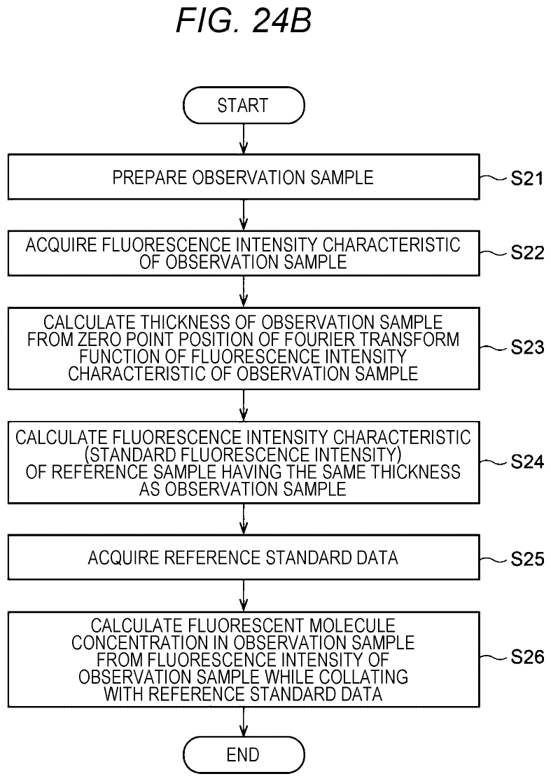

FIG. 24A is a flowchart illustrating an example of processing of acquiring the fluorescent molecule concentration in the observation sample.

First, the observation sample is prepared (Sl1 in FIG. 24A). Preparation of the observation sample can be performed by any method. For example, the observation sample is prepared by the similar method as the preparation of the reference sample described above (see S1 in FIG. 18).

Thereafter, the fluorescence intensity in the fluorescence image of the observation sample is acquired by the information processing system including the line confocal microscope and the information processing apparatus described above (S12 in FIG. 24A). Specifically, the fluorescence intensity in the fluorescence image of the observation sample is acquired in the similar method as the acquisition of the fluorescence intensity characteristic of the reference sample described above (see S2 in FIG. 18).

Note that, in this example, the fluorescence image of the observation sample may be captured only with respect to a single focal position (for example, the origin). That is, the line confocal microscope may acquire the fluorescence image of the observation sample by imaging the observation sample while fixing the focal position of the optical system.

Thereafter, the fluorescent molecule concentration in the observation sample is calculated from the fluorescence intensity of the observation sample while collating with the reference standard data (S13 in FIG. 24A). The reference standard data used in the calculation processing is acquired from the fluorescent molecule concentration and the fluorescence intensity characteristic of the reference sample (see S1 to S6 in FIG. 18).

The fluorescent molecule concentration ratio between the reference sample and the observation sample is equal to the ratio of the fluorescence intensity in the fluorescence image between the reference sample and the observation sample. Therefore, the fluorescence intensity ratio between the reference sample and the observation sample is calculated from the fluorescence intensity of the observation sample acquired in step S12 described above and the corresponding fluorescence intensity of the reference sample obtained from the reference standard data. Then, the fluorescent molecule concentration in the observation sample is derived by multiplying the standard fluorescent molecule concentration obtained from the reference standard data by the fluorescence intensity ratio between the reference sample and the observation sample.

In general, the focal position of the line confocal microscope is set to a standard focal position (origin of the focal position), and often coincides with the center position in the optical axis direction of the sample (reference sample and observation sample) to be imaged. In this case, the fluorescence intensity in the fluorescence image of the observation sample is the fluorescence intensity indicated by the origin (=“0”) in the fluorescence intensity characteristic of the observation sample, and is usually a peak value (maximum value) of the fluorescence intensity characteristics. Therefore, in this case, the “standard fluorescence intensity” associated with the standard fluorescent molecule concentration by the reference standard data is the fluorescence intensity indicated by the origin (=“0”) among the fluorescence intensity characteristic (desired thickness fluorescence intensity characteristic) of the reference sample having the same thickness as the observation sample.

However, the focal position of the line confocal microscope may be shifted from the standard focal position (origin of the focal position), and may not coincide with the center position in the optical axis direction of the sample to be imaged.

In this case, the shift of the focal position of the line confocal microscope may be predicted in advance by using another optical system, and the fluorescent molecule concentration in the observation sample may be calculated on the basis of the fluorescence intensity of the reference sample at the predicted focal position (that is, the focal position shifted from the standard focal position). That is, in the fluorescence intensity characteristic of the reference sample having the same thickness as the observation sample, the fluorescence intensity related to the actual focal position of the optical system at the time of capturing the fluorescence image of the observation sample may be used as the standard fluorescence concentration of the reference standard data in calculating the fluorescent molecule concentration in the observation sample.

FIG. 24B is a flowchart illustrating another example of processing of acquiring the fluorescent molecule concentration in the observation sample.

In the flowchart illustrated in FIG. 24A, the reference standard data is prepared according to the known thickness of the observation sample, but the thickness of the observation sample may be calculated from the fluorescence intensity characteristic of the observation sample similarly to the thickness of the reference sample.

In this example, the observation sample is prepared (S21 in FIG. 24B), and thereafter, the fluorescence intensity characteristic of the observation sample is acquired (S22). Specifically, the line confocal microscope images the observation sample while changing the focal position of the optical system to acquire a plurality of fluorescence images, and the information processing apparatus acquires the fluorescence intensity of the plurality of fluorescence images to derive the fluorescence intensity characteristic of the observation sample.

Thereafter, the thickness of the observation sample is calculated from the fluorescence intensity characteristic of the observation sample by a method similar to the above-described “method of calculating the thickness of the reference sample from the fluorescence intensity characteristic of the reference sample” (see S3 in FIG. 18). That is, the thickness of the observation sample is calculated from the zero point position of the Fourier transform function of the fluorescence intensity characteristic of the observation sample (S23 in FIG. 24B).

Thereafter, the fluorescence intensity characteristic (standard fluorescence intensity) of the reference sample having the same thickness as the observation sample is calculated (S24 in FIG. 24B) by the above-described method (S4 and S5 in FIG. 18), and the reference standard data is acquired (S25).

Thereafter, the fluorescent molecule concentration in the observation sample is calculated from the fluorescence intensity characteristic (fluorescence intensity) of the observation sample while collating with the reference standard data (S26 in FIG. 24B) by a method similar to the processing flow shown in FIG. 24A (in particular, S13 in FIG. 24A).

### [Operations and Effects]

As described above, according to the information processing apparatus and the information processing method of the above-described embodiment, the measurement system (image acquisition unit) of the line confocal microscope acquires the fluorescence image (observation fluorescence image) of the observation sample by using the optical system in which the fluorescence intensity in the captured image changes according to the focal position. Then, the fluorescence information analysis unit 133 of the information processing apparatus 100 (see FIG. 1; the fluorescence intensity acquisition unit) analyzes the observation fluorescence image to acquire the fluorescence intensity (observation fluorescence intensity) in the observation fluorescence image. Then, the fluorescence information analysis unit 133 (fluorescent molecule concentration deriving unit) derives the fluorescent molecule concentration in the observation sample from the observation fluorescence intensity while collating with the reference standard data that associates the standard fluorescent molecule concentration with the standard fluorescence intensity. The standard fluorescence intensity is derived by the fluorescence information analysis unit 133 from the plurality of fluorescence images (reference fluorescence images) of the reference sample captured and acquired by using the optical system in which the fluorescence intensity in the captured image changes according to the focal position, the plurality of reference fluorescence images having different focal positions at the time of imaging. Furthermore, the standard fluorescent molecule concentration is obtained by the fluorescence information analysis unit 133 from the fluorescent molecule concentration in the reference sample. The reference standard data is acquired by the fluorescence information analysis unit 133 on the basis of the standard fluorescence intensity and the standard fluorescent molecule concentration obtained in this manner.

By handling the fluorescence image in consideration of such focal characteristics, the fluorescent molecule concentration in the observation sample can be accurately determined on the basis of the fluorescence image of the observation sample.

Furthermore, the plurality of reference fluorescence images is analyzed to obtain the fluorescence intensity (reference fluorescence intensity) in each reference fluorescence image. Then, the reference fluorescence intensity characteristic that associates the focal position and the reference fluorescence intensity with each other is acquired from the reference fluorescence intensity of each of the plurality of reference fluorescence images. Then, the fluorescence intensity characteristic (standard thickness reference fluorescence intensity characteristic) of the reference sample in a case where the reference sample is assumed to have the standard thickness is derived on the basis of the reference fluorescence intensity characteristic and the thickness of the reference sample in the optical axis direction. Then, the standard fluorescence intensity is derived on the basis of the thickness of the observation sample in the optical axis direction and the standard thickness reference fluorescence intensity characteristic.

With this arrangement, even in a case where the thickness of the observation sample can be changed, the appropriate standard fluorescence intensity corresponding to the thickness of the observation sample is reflected in the reference standard data, and as a result, the fluorescent molecule concentration in the observation sample can be accurately obtained.

Particularly, the standard thickness reference fluorescence intensity characteristic in the present embodiment represents the fluorescence intensity characteristic of the reference sample in a case where the reference sample is assumed to have the infinitely thin thickness.

The fluorescence intensity characteristic of the reference sample having such an infinitely thin thickness can be easily calculated by deconvolution of the reference fluorescence intensity characteristic and the thickness of the reference sample in the optical axis direction.

Furthermore, the Fourier observation sample thickness function is obtained on the basis of the Fourier transform of the rectangular function corresponding to the thickness of the observation sample in the optical axis direction. Furthermore, the Fourier standard thickness reference fluorescence intensity characteristic is also obtained on the basis of the Fourier transform of the standard thickness reference fluorescence intensity characteristic. Then, the Fourier desired thickness fluorescence intensity characteristic is acquired on the basis of the inner product of the Fourier observation sample thickness function and the Fourier standard thickness reference fluorescence intensity characteristic. Then, the standard fluorescence intensity is acquired on the basis of the inverse Fourier transform of the Fourier desired thickness fluorescence intensity characteristic.

By using the Fourier transform and the inverse Fourier transform in this manner, a reduction in operation load and an increase in operation speed can be expected.

A function obtained by performing the Fourier transform on the reference fluorescence intensity characteristic is “F_{L}(k)”. Furthermore, a function obtained by performing the Fourier transform on the rectangular function corresponding to the thickness of the reference sample in the optical axis direction is represented by “G_{L}(k)”, and a complex conjugate of a function obtained by performing the Fourier transform on the rectangular function is represented by “G_{L}*(k)”. Furthermore, a minute number other than “0 (zero)” is represented as “ε”. In this case, the Fourier standard thickness reference fluorescence intensity characteristic, which is the Fourier transform function of the standard thickness reference fluorescence intensity characteristic, is derived by F_{L} (k)·G_{L}*(k)/(G_{L}*(k)·G_{L} (k)+ε²).

In this case, the above-described arithmetic operation based on the Fourier transform function can be performed while avoiding division by “0 (zero)”, and the stable calculation processing can be performed.

In particular, the above-described minute number “ε” may be a value that is equal to or less than 1/1000 of the maximum value of the absolute value of the value indicated by the function (F_{L}(k)) obtained by performing the Fourier transform on the reference fluorescence intensity characteristic.

The use of such a minute number “ε” is advantageous for performing the stable arithmetic processing while suppressing the influence of the minute number “ε” on the arithmetic operation result.

Furthermore, the smoothing processing is applied to the Fourier desired thickness fluorescence intensity characteristic, and the data of the singular point in the Fourier desired thickness fluorescence intensity characteristic is corrected on the basis of the data before and after the singular point. Then, the standard fluorescence intensity is acquired on the basis of the Fourier desired thickness fluorescence intensity characteristic of after the smoothing processing.

With this arrangement, the spurious in the Fourier desired thickness fluorescence intensity characteristic can be reduced to improve the calculation accuracy of the fluorescence intensity characteristic of the reference sample having a desired thickness, which is advantageous for acquiring a more appropriate standard fluorescence intensity.

Specifically, the singular point correction filter is applied to the Fourier desired thickness fluorescence intensity characteristic in the smoothing processing, and the data of the singular point of the Fourier desired thickness fluorescence intensity characteristic is corrected to the data obtained by the linear interpolation based on data before and after the data of the singular point.

With this arrangement, the data of the singular point of the Fourier desired thickness fluorescence intensity characteristic can be easily corrected.

Furthermore, the thickness of the reference sample in the optical axis direction used in deriving the standard thickness reference fluorescence intensity characteristic is derived on the basis of the frequency (zero point position) at which the amplitude of the function obtained by performing the Fourier transform on the reference fluorescence intensity characteristic indicates zero.

In this case, the thickness of the reference sample in the optical axis direction can be accurately obtained on the basis of the “frequency” and the “amplitude” in the frequency domain after the Fourier transform, and as a result, the standard thickness reference fluorescence intensity characteristic can be appropriately derived. In particular, as the reference sample becomes thinner, the thickness of the reference sample using a measuring instrument becomes difficult to be accurately measured, but according to the behavior of the reference fluorescence intensity characteristic in the frequency domain, the thickness of the reference sample can be accurately acquired without using the measuring instrument even if the reference sample is thin.

Furthermore, the plurality of observation fluorescence images having different focal positions at the time of imaging may be analyzed to acquire the observation fluorescence intensity of each of the plurality of observation fluorescence images. In this case, the observation fluorescence intensity characteristic that associates the focal position and the observation fluorescence intensity with each other is acquired from the observation fluorescence intensity of each of the plurality of observation fluorescence images. The Fourier transform function (Fourier observation sample thickness function) of a rectangular function corresponding to the thickness of the observation sample is obtained on the basis of the thickness of the observation sample in the optical axis direction and derived on the basis of the frequency at which the amplitude of the function obtained by performing the Fourier transform on the observation fluorescence intensity characteristic indicates zero.

With this arrangement, the thickness of the observation sample in the optical axis direction can be acquired with high accuracy, and furthermore, the appropriate reference standard data (in particular, standard fluorescence intensity) can be obtained.

Furthermore, the above-described information processing system (microscope system) includes a light irradiation unit (for example, the excitation light source 510, the beam splitter 511, and the objective lens 512 illustrated in FIG. 10.), an imaging device (for example, the photodetector 514 illustrated in FIG. 10), and the information processing apparatus. The light irradiation unit irradiates the observation sample with the excitation light that excites the fluorescent reagent. The imaging device captures the image of the sample irradiated with the excitation light and acquires the fluorescence image by using an optical system (for example, the light passage restricting element 61 having the slit 62 illustrated in FIGS. 12B and 12C) in which the fluorescence intensity in the captured image changes according to the focal position. The information processing apparatus analyzes the fluorescence image and derives the fluorescent molecule concentration in the observation sample from the observation fluorescence intensity as described above.

### [Modifications]

In the above-described embodiment, the fluorescent molecule concentration in the observation sample is acquired in consideration of the focal characteristics of the fluorescence image captured and acquired by the confocal microscope, but the above-described technology may be applied to other applications. For example, even in a case where the fluorescent molecule concentration in the observation sample is not acquired, the above-described technique in consideration of the focal characteristics may be used to derive the thickness of the sample (fluorescent-stained specimen).

That is, a plurality of sample fluorescence images, which is a plurality of fluorescence images of a target sample, may be captured and acquired by using an optical system in which the fluorescence intensity in the captured image changes according to the focal position. In this case, a sample fluorescence intensity representing the fluorescence intensity in each sample fluorescence image can be acquired by analyzing the plurality of sample fluorescence images having different focal positions from each other at the time of imaging. Then, a sample fluorescence intensity characteristic that associates the focal position and the sample fluorescence intensity with each other can be acquired from the sample fluorescence intensity of each of the plurality of sample fluorescence images. Then, the thickness of the sample in the optical axis direction can be derived on the basis of the frequency at which the amplitude of the function obtained by performing the Fourier transform on the sample fluorescence intensity characteristic indicates zero.

Furthermore, the sample may be stained with a first fluorescent staining reagent that stains the sample according to a specific cell state (for example, a state of a specific protein (antigen)) and a second fluorescent staining reagent that stains the sample regardless of the specific cell state. In this case, the specific cell state of the sample can be confirmed by deriving the fluorescent molecule concentration of the first fluorescent staining reagent by using the image based on the fluorescence of the first fluorescent staining reagent as the above-described observation fluorescence image. Meanwhile, the thickness of the sample in the optical axis direction can be derived by acquiring the sample fluorescence intensity of the second fluorescent staining reagent by using the image based on the fluorescence of the second fluorescent staining reagent as the above-described sample fluorescence image.

In order to derive the thickness of the sample in this manner, another staining reagent (second staining reagent) different from the staining reagent (first staining reagent) for detecting a specific cell state of the sample may be used. By using the second fluorescent staining reagent that stains the sample regardless of a specific cell state in order to derive the thickness of the sample, the thickness of the sample can be accurately derived regardless of the specific cell state of the sample.

Note that the staining reagent (second staining reagent) used to derive the thickness of the sample is preferably a reagent that can uniformly stain the entire sample, and furthermore, is preferably a reagent that does not cause degradation of the sample (biological tissue) as much as possible.

In the embodiment and the modification described above, in case where the thickness of the sample is derived from the fluorescence intensity characteristic of the sample (including the reference sample and the observation sample), the thickness distribution in each sample may be acquired. The above-described method of deriving the thickness of the sample from the fluorescence intensity characteristic basically derives the thickness of the sample at the imaging location of the fluorescence image constituting the basic data for deriving the fluorescence intensity characteristic. Therefore, the thickness of the sample at each of the plurality of locations can be derived from the fluorescence intensity characteristic of the fluorescence image at the plurality of locations of the sample.

For example, in a case where the thickness distribution of the observation sample is acquired from the fluorescence intensity characteristic of the observation sample, it is preferable to obtain the reference standard data derived from the reference sample (standard fluorescence intensity derived from the reference fluorescence image) on the basis of the thickness distribution of the observation sample. In this case, the fluorescent molecule concentration in the observation sample can be derived by using the reference standard data optimized according to the thickness of the observation sample at each of the plurality of locations.

The above-described processing can be executed by an optional information processing apparatus, and can be executed by, for example, the fluorescence information analysis unit 133 illustrated in FIG. 1.

It should be noted that the embodiment and modifications disclosed in the present specification are illustrative only in all respects and are not to be construed as limiting. The above-described embodiment and modifications can be omitted, replaced, and changed in various forms without departing from the scope and spirit of the appended claims. For example, the above-described embodiment and modifications may be combined in whole or in part, and other embodiments may be combined with the above-described embodiment or modifications. Furthermore, the effects of the present disclosure described in the present description are merely exemplification, and other effects may be provided.

A technical category embodying the above technical idea is not limited. For example, the above-described technical idea may be embodied by a computer program for causing a computer to execute one or a plurality of procedures (steps) included in a method of manufacturing or using the above-described apparatus. Furthermore, the above-described technical idea may be embodied by a computer-readable non-transitory recording medium in which such a computer program is recorded.

### [Supplementary Note]

The present disclosure can also have the following configurations.

### [Item 1]

An information processing method including the steps of:
analyzing an observation fluorescence image that is a fluorescence image of an observation sample captured and acquired by using an optical system in which fluorescence intensity in a captured image changes according to a focal position and acquiring an observation fluorescence intensity representing fluorescence intensity in the observation fluorescence image; and
deriving a fluorescent molecule concentration in the observation sample from the observation fluorescence intensity while collating with reference standard data that associates a standard fluorescent molecule concentration and standard fluorescence intensity with each other, in which
the reference standard data is obtained on the basis of the standard fluorescence intensity and the standard fluorescent molecule concentration, the standard fluorescence intensity being derived from a plurality of reference fluorescence images that is a plurality of fluorescence images of a reference sample captured and acquired by using an optical system in which fluorescence intensity in a captured image changes according to a focal position, the plurality of reference fluorescence images having different focal position at the time of imaging from each other, and the standard fluorescent molecule concentration being obtained from a fluorescent molecule concentration in the reference sample.

### [Item 2]

The information processing method according to Item 1, in which the information processing method includes:
analyzing the plurality of reference fluorescence images to acquire a reference fluorescence intensity representing fluorescence intensity in each of the reference fluorescence images;
acquiring a reference fluorescence intensity characteristic that associates a focal position and the reference fluorescence intensity with each other from the reference fluorescence intensity of each of the plurality of reference fluorescence images;
deriving a standard thickness reference fluorescence intensity characteristic representing a fluorescence intensity characteristic of the reference sample in a case where the reference sample is assumed to have a standard thickness, on the basis of the reference fluorescence intensity characteristic and a thickness of the reference sample in an optical axis direction; and
deriving the standard fluorescence intensity on the basis of a thickness of the observation sample in the optical axis direction and the standard thickness reference fluorescence intensity characteristic.

### [Item 3]

The information processing method according to Item 2, in which
the standard thickness reference fluorescence intensity characteristic represents a fluorescence intensity characteristic of the reference sample in a case where the reference sample is assumed to have an infinitely thin thickness.

### [Item 4]

The information processing method according to Item 2 or 3, in which the information processing method includes:
acquiring a Fourier desired thickness fluorescence intensity characteristic on the basis of an inner product between a Fourier observation sample thickness function and a Fourier standard thickness reference fluorescence intensity characteristic, the Fourier observation sample thickness function being obtained on the basis of Fourier transform of a rectangular function corresponding to the thickness of the observation sample in the optical axis direction, and the Fourier standard thickness reference fluorescence intensity characteristic being obtained on the basis of Fourier transform of the standard thickness reference fluorescence intensity characteristic; and
acquiring the standard fluorescence intensity on the basis of inverse Fourier transform of the Fourier desired thickness fluorescence intensity characteristic.

### [Item 5]

The information processing method according to Item 4, in which the information processing method includes
deriving the Fourier standard thickness reference fluorescence intensity characteristic on the basis of

$${F}_{L} ( k ) \cdot {G}_{L}^{⋆} / ( {G}_{L}^{⋆} ( k ) \cdot {G}_{L} ( k ) + {ε}^{2} ) ,$$

in a case where a function obtained by performing Fourier transform on the reference fluorescence intensity characteristic is represented by “F_{L}(k)”,
in a case where a function obtained by performing Fourier transform on the rectangular function corresponding to the thickness of the reference sample in the optical axis direction is represented by “G_{L}(k)”, and a complex conjugate of a function obtained by performing Fourier transform on the rectangular function is represented by “G_{L}*(k)”, and
in a case where a minute number other than 0 is represented by “ε”.

### [Item 6]

The information processing method according to Item 5, in which
the minute number is a value that is equal to or less than 1/1000 of a maximum value of an absolute value of a value indicated by a function obtained by performing Fourier transform on the reference fluorescence intensity characteristic.

### [Item 7]

The information processing method according to any one of Items 4 to 6, in which the information processing method includes:
applying smoothing processing to the Fourier desired thickness fluorescence intensity characteristic to correct data of a singular point in the Fourier desired thickness fluorescence intensity characteristic on the basis of data before and after the singular point; and
acquiring the standard fluorescence intensity on the basis of the Fourier desired thickness fluorescence intensity characteristic of after the smoothing processing.

### [Item 8]

The information processing method according to Item 7, in which the information processing method includes
applying a singular point correction filter to the Fourier desired thickness fluorescence intensity characteristic in the smoothing processing, and correcting the data of the singular point of the Fourier desired thickness fluorescence intensity characteristic to data obtained by linear interpolation based on data before and after the data of the singular point.

### [Item 9]

The information processing method according to any one of Items 2 to 8, in which
the thickness of the reference sample in the optical axis direction used in deriving the standard thickness reference fluorescence intensity characteristic is derived on the basis of a frequency at which an amplitude of a function obtained by performing Fourier transform on the reference fluorescence intensity characteristic indicates zero.

### [Item 10]

The information processing method according to any one of Items 4 to 9, in which the information processing method includes:
analyzing a plurality of observation fluorescence images having different focal positions at the time of imaging from each other to acquire the observation fluorescence intensity of each of the plurality of observation fluorescence images;
acquiring an observation fluorescence intensity characteristic that associates a focal position and the observation fluorescence intensity with each other from the observation fluorescence intensity of each of the plurality of observation fluorescence images; and
obtaining the Fourier observation sample thickness function on the basis of the thickness of the observation sample in the optical axis direction, the thickness being derived on the basis of a frequency at which an amplitude of a function obtained by performing Fourier transform on the observation fluorescence intensity characteristic indicates zero.

### [Item 11]

An information processing method including the steps of:
analyzing a plurality of sample fluorescence images that is a plurality of fluorescence images of a sample captured and acquired by using an optical system in which fluorescence intensity in a captured image changes according to a focal position, the plurality of sample fluorescence images having different focal positions at a time of imaging from each other, to acquire sample fluorescence intensity representing fluorescence intensity in each of the sample fluorescence images;
acquiring a sample fluorescence intensity characteristic that associates a focal position and the sample fluorescence intensity with each other from the sample fluorescence intensity of each of the plurality of sample fluorescence images; and
deriving a thickness of the sample in an optical axis direction on the basis of a frequency at which an amplitude of a function obtained by performing Fourier transform on the sample fluorescence intensity characteristic indicates zero.

### [Item 12]

The information processing method according to Item 11, in which
the sample is stained with a first fluorescent staining reagent that stains the sample according to a specific cell state and a second fluorescent staining reagent that stains the sample regardless of the specific cell state, and
the plurality of sample fluorescence images is an image based on fluorescence of the second fluorescent staining reagent.

### [Item 13]

An information processing apparatus including
an image acquisition unit that captures and acquires an observation fluorescence image that is a fluorescence image of an observation sample by using an optical system in which fluorescence intensity in a captured image changes according to a focal position;
a fluorescence intensity acquisition unit that acquires an observation fluorescence intensity representing fluorescence intensity in the observation fluorescence image by analyzing the observation fluorescence image; and
a fluorescent molecule concentration deriving unit that derives a fluorescent molecule concentration in the observation sample from the observation fluorescence intensity while collating with reference standard data that associates a standard fluorescent molecule concentration and standard fluorescence intensity with each other, in which
the reference standard data is obtained on the basis of the standard fluorescence intensity and the standard fluorescent molecule concentration, the standard fluorescence intensity being derived from a plurality of reference fluorescence images that is a plurality of fluorescence images of a reference sample captured by using an optical system in which fluorescence intensity in a captured image changes according to a focal position, the plurality of reference fluorescence images having different focal positions at the time of imaging from each other, and the standard fluorescent molecule concentration being obtained from a fluorescent molecule concentration in the reference sample.

### [Item 14]

A microscope system including:
a light irradiation unit that irradiates an observation sample with excitation light that excites a fluorescent reagent;
an imaging device that images a sample irradiated with the excitation light by using an optical system in which fluorescence intensity in a captured image changes according to a focal position, and acquires a fluorescence image; and
an information processing apparatus that analyzes the fluorescence image, in which
the information processing apparatus includes the processes of:
analyzing an observation fluorescence image that is a fluorescence image of the observation sample to acquire an observation fluorescence intensity representing fluorescence intensity in the observation fluorescence image; and
deriving a fluorescent molecule concentration in the observation sample from the observation fluorescence intensity while collating with reference standard data that associates a standard fluorescent molecule concentration and standard fluorescence intensity with each other, and
the reference standard data is obtained on the basis of the standard fluorescence intensity and the standard fluorescent molecule concentration, the standard fluorescence intensity being derived from a plurality of reference fluorescence images that is a plurality of fluorescence images of a reference sample captured by using an optical system in which fluorescence intensity in a captured image changes according to a focal position, the plurality of reference fluorescence images having different focal positions at the time of imaging from each other, and the standard fluorescent molecule concentration being obtained from a fluorescent molecule concentration in the reference sample.

### REFERENCE SIGNS LIST

10 Fluorescent reagent
11 Reagent identification information
20 Specimen
21 Specimen identification information
30 Fluorescent-stained specimen
35 Standard thickness reference fluorescence intensity characteristic
36 Desired thickness rectangular function
60 Image sensor
61 Light passage restricting element
62 Slit
100 Information processing apparatus
101 Measurement system
102 Information processing system
110 Acquisition unit
111 Information acquisition unit
112 Fluorescence signal acquisition unit
120 Storage unit
121 Information storage unit
122 Fluorescence signal storage unit
130 Processing unit
131 Combining unit
132 Separation processing unit
133 Fluorescence information analysis unit
134 Image generation unit
140 Display unit
150 Control unit
160 Operation unit
200 Database
210 Fluorescence spectrum
1321 Color separation unit
1321a First color separation unit
1321b Second color separation unit
1322 Spectrum extraction unit
L1 Excitation light
L2 Fluorescence

1. An information processing method comprising the steps of:
analyzing an observation fluorescence image that is a fluorescence image of an observation sample captured and acquired by using an optical system in which fluorescence intensity in a captured image changes according to a focal position and acquiring an observation fluorescence intensity representing fluorescence intensity in the observation fluorescence image; and
deriving a fluorescent molecule concentration in the observation sample from the observation fluorescence intensity while collating with reference standard data that associates a standard fluorescent molecule concentration and standard fluorescence intensity with each other, wherein
the reference standard data is obtained on a basis of the standard fluorescence intensity and the standard fluorescent molecule concentration, the standard fluorescence intensity being derived from a plurality of reference fluorescence images that is a plurality of fluorescence images of a reference sample captured and acquired by using an optical system in which fluorescence intensity in a captured image changes according to a focal position, the plurality of reference fluorescence images having different focal positions at a time of imaging from each other, and the standard fluorescent molecule concentration being obtained from a fluorescent molecule concentration in the reference sample.

2. The information processing method according to claim 1, wherein the information processing method comprises:
analyzing the plurality of reference fluorescence images to acquire a reference fluorescence intensity representing fluorescence intensity in each of the reference fluorescence images;
acquiring a reference fluorescence intensity characteristic that associates a focal position and the reference fluorescence intensity with each other from the reference fluorescence intensity of each of the plurality of reference fluorescence images;
deriving a standard thickness reference fluorescence intensity characteristic representing a fluorescence intensity characteristic of the reference sample in a case where the reference sample is assumed to have a standard thickness, on a basis of the reference fluorescence intensity characteristic and a thickness of the reference sample in an optical axis direction; and
deriving the standard fluorescence intensity on a basis of a thickness of the observation sample in the optical axis direction and the standard thickness reference fluorescence intensity characteristic.

3. The information processing method according to claim 2, wherein
the standard thickness reference fluorescence intensity characteristic represents a fluorescence intensity characteristic of the reference sample in a case where the reference sample is assumed to have an infinitely thin thickness.

4. The information processing method according to claim 2, wherein the information processing method comprises:
acquiring a Fourier desired thickness fluorescence intensity characteristic on a basis of an inner product between a Fourier observation sample thickness function and a Fourier standard thickness reference fluorescence intensity characteristic, the Fourier observation sample thickness function being obtained on a basis of Fourier transform of a rectangular function corresponding to the thickness of the observation sample in the optical axis direction, and the Fourier standard thickness reference fluorescence intensity characteristic being obtained on a basis of Fourier transform of the standard thickness reference fluorescence intensity characteristic; and
acquiring the standard fluorescence intensity on a basis of inverse Fourier transform of the Fourier desired thickness fluorescence intensity characteristic.

5. The information processing method according to claim 4, wherein the information processing method comprises
deriving the Fourier standard thickness reference fluorescence intensity characteristic on a basis of
$${F}_{L} ( k ) \cdot {G}_{L}^{⋆} ( k ) / ( {G}_{L}^{⋆} ( k ) \cdot {G}_{L} ( k ) + {ε}^{2} ) ,$$
in a case where a function obtained by performing Fourier transform on the reference fluorescence intensity characteristic is represented by “F_{L}(k)”,
in a case where a function obtained by performing Fourier transform on the rectangular function corresponding to the thickness of the reference sample in the optical axis direction is represented by “G_{L}(k)”, and a complex conjugate of a function obtained by performing Fourier transform on the rectangular function is represented by “G_{L}*(k)”, and
in a case where a minute number other than 0 is represented by “ε”.

6. The information processing method according to claim 5, wherein
the minute number is a value that is equal to or less than 1/1000 of a maximum value of an absolute value of a value indicated by a function obtained by performing Fourier transform on the reference fluorescence intensity characteristic.

7. The information processing method according to claim 4, wherein the information processing method comprises:
applying smoothing processing to the Fourier desired thickness fluorescence intensity characteristic to correct data of a singular point in the Fourier desired thickness fluorescence intensity characteristic on a basis of data before and after the singular point; and
acquiring the standard fluorescence intensity on a basis of the Fourier desired thickness fluorescence intensity characteristic of after the smoothing processing.

8. The information processing method according to claim 7, wherein the information processing method comprises
applying a singular point correction filter to the Fourier desired thickness fluorescence intensity characteristic in the smoothing processing, and correcting the data of the singular point of the Fourier desired thickness fluorescence intensity characteristic to data obtained by linear interpolation based on data before and after the data of the singular point.

9. The information processing method according to claim 2, wherein
the thickness of the reference sample in the optical axis direction used in deriving the standard thickness reference fluorescence intensity characteristic is derived on a basis of a frequency at which an amplitude of a function obtained by performing Fourier transform on the reference fluorescence intensity characteristic indicates zero.

10. The information processing method according to claim 4, wherein the information processing method comprises:
analyzing a plurality of observation fluorescence images having different focal positions at a time of imaging from each other to acquire the observation fluorescence intensity of each of the plurality of observation fluorescence images;
acquiring an observation fluorescence intensity characteristic that associates a focal position and the observation fluorescence intensity with each other from the observation fluorescence intensity of each of the plurality of observation fluorescence images; and
obtaining the Fourier observation sample thickness function on a basis of the thickness of the observation sample in the optical axis direction, the thickness being derived on a basis of a frequency at which an amplitude of a function obtained by performing Fourier transform on the observation fluorescence intensity characteristic indicates zero.

11. An information processing method comprising the steps of:
analyzing a plurality of sample fluorescence images that is a plurality of fluorescence images of a sample captured and acquired by using an optical system in which fluorescence intensity in a captured image changes according to a focal position, the plurality of sample fluorescence images having different focal positions from each other at a time of imaging, to acquire sample fluorescence intensity representing fluorescence intensity in each of the sample fluorescence images;
acquiring a sample fluorescence intensity characteristic that associates a focal position and the sample fluorescence intensity with each other from the sample fluorescence intensity of each of the plurality of sample fluorescence images; and
deriving a thickness of the sample in an optical axis direction on a basis of a frequency at which an amplitude of a function obtained by performing Fourier transform on the sample fluorescence intensity characteristic indicates zero.

12. The information processing method according to claim 11, wherein
the sample is stained with a first fluorescent staining reagent that stains the sample according to a specific cell state and a second fluorescent staining reagent that stains the sample regardless of the specific cell state, and
the plurality of sample fluorescence images is an image based on fluorescence of the second fluorescent staining reagent.

13. An information processing apparatus comprising:
an image acquisition unit that captures and acquires an observation fluorescence image that is a fluorescence image of an observation sample by using an optical system in which fluorescence intensity in a captured image changes according to a focal position;
a fluorescence intensity acquisition unit that acquires an observation fluorescence intensity representing fluorescence intensity in the observation fluorescence image by analyzing the observation fluorescence image; and
a fluorescent molecule concentration deriving unit that derives a fluorescent molecule concentration in the observation sample from the observation fluorescence intensity while collating with reference standard data that associates a standard fluorescent molecule concentration and standard fluorescence intensity with each other, wherein
the reference standard data is obtained on a basis of the standard fluorescence intensity and the standard fluorescent molecule concentration, the standard fluorescence intensity being derived from a plurality of reference fluorescence images that is a plurality of fluorescence images of a reference sample captured by using an optical system in which fluorescence intensity in a captured image changes according to a focal position, the plurality of reference fluorescence images having different focal positions at a time of imaging from each other, and the standard fluorescent molecule concentration being obtained from a fluorescent molecule concentration in the reference sample.

14. A microscope system comprising:
a light irradiation unit that irradiates an observation sample with excitation light that excites a fluorescent reagent;
an imaging device that images a sample irradiated with the excitation light by using an optical system in which fluorescence intensity in a captured image changes according to a focal position, and acquires a fluorescence image; and
an information processing apparatus that analyzes the fluorescence image, wherein
the information processing apparatus comprises the processes of:
analyzing an observation fluorescence image that is a fluorescence image of the observation sample to acquire an observation fluorescence intensity representing fluorescence intensity in the observation fluorescence image; and
deriving a fluorescent molecule concentration in the observation sample from the observation fluorescence intensity while collating with reference standard data that associates a standard fluorescent molecule concentration and standard fluorescence intensity with each other, and
the reference standard data is obtained on a basis of the standard fluorescence intensity and the standard fluorescent molecule concentration, the standard fluorescence intensity being derived from a plurality of reference fluorescence images that is a plurality of fluorescence images of a reference sample captured by using an optical system in which fluorescence intensity in a captured image changes according to a focal position, the plurality of reference fluorescence images having different focal positions at a time of imaging from each other, and the standard fluorescent molecule concentration being obtained from a fluorescent molecule concentration in the reference sample.
